(19) United States
(12) Patent Application Publication
(10) Pub. No.: US 2008/0023324 A1
(43) Pub. Date: Jan. 31, 2008

(54) Analytical microchannel device

(75) Inventors: Kazuo Ban, Nara-shi (JP); Seung-jin Cho, Nara-shi (JP); Tatsuhito Arimura, Nara-shi (JP)

Correspondence Address: NIXON & VANDERHYE, PC, 901 NORTH GLEBE ROAD, 11TH FLOOR, ARLINGTON, VA, 22203, US

(73) Assignee: Sharp Kabushiki Kaisha, Osaka (JP)

(21) Appl. No.: 11/878,774

(22) Filed: Jul. 26, 2007

(30) Foreign Application Priority Data
Jul. 28, 2006 (JP) 2006-205748
Jul. 5, 2007 (JP) 2007-177225

(51) Int. Cl. G01N 27/26; B01J 19/00

(52) U.S. Cl. 204/400; 422/68.1

(57) ABSTRACT

An analytical microchannel device that detects specimens such as allergen with high sensitivity is provided. The analytical microchannel device includes a plurality of channels, a reaction substance-holding portion disposed on or in any of the channels, an electrochemical detection-dedicated electrode disposed on a channel located on a lower stream relative to the channel provided with the reaction substance. The analytical microchannel device includes means to bend the solution flow vertically at the reaction substance-holding portion, and means to make the solution flow hit the electrochemical detection-dedicated electrode at a substantially right angle.

### BACKGROUND OF THE INVENTION

1) Field of the Invention

The present invention relates to an analytical microchannel device for measuring the amount of specimens (e.g., allergens) as desired materials contained in test solutions.

2) Description of the Related Art

Immune analysis utilizing the antibody-antigen reaction is used as a significant means of analysis and measurement in fields including medical treatment, biochemistry, and allergen analysis. Conventional immune analysis, however, posed problems including involving at least one day for analysis, involving complicated handling, and so forth.

Meanwhile, WO2003-062823 and Japanese Patent Application Publication No. 2003-285298 (hereinafter referred to as patent documents 1 and 2, respectively) suggest microdevices with channels (paths) in micro scale formed on a substrate. The microchannels have substances immobilized therein including antibodies, thus attempting to shorten the analysis time and simplify handling for analysis.

Patent document 1 relates to a microdevice with microchannels having therein fine reaction particles of plastic or glass with antigens or antibodies immobilized on the surfaces. This technique reduces the size of the reaction field (the area filled with the reaction fine particles) and enlarges the reaction surface area, thus realizing miniaturization of the device and a large reduction in the time required for reaction.

The structure of the microdevice related to the above-described technique is shown in FIG. 33, to which reference will be made in describing the technique in detail below. Referring to FIG. 33, the microdevice includes, on a glass or plastic substrate 601, channels 608 and 609, a damming portion 620, introducing apertures 603 and 604, and a discharging aperture 607. Also, an electrode 613 for detecting oxidation-reduction current of a substance resulting from an enzyme reaction is formed on the surface of a silicon substrate 602. The substrates 601 and 602 are superposed on one another so that the channels and the electrode face each other.

Fine particles 605 having immobilized thereon antibodies that react exclusively to a specimen is dispersed in a buffer solution, which is then introduced into the chip through the introducing aperture 603. The fine particles 605 are dammed by the damming portion 620 so that the fine particles 605 will not drain. Referring to FIG. 33(b), the distance between the uppermost end of the damming portion 620 and the substrate 602 is less than the diameter of the fine particles 605.

Now description will be made of how this device is used. In order to wash the interior of the chip and make the liquid flow uniform, a buffer solution is introduced through the introducing aperture 603 using an external pump or the like, and then discharged from the discharging aperture 607 through the channels 608 and 609.

Then, a test solution containing the specimen is introduced through the introducing aperture 604 using an external pump or the like, and the test solution is allowed to react to the fine particles 605, which have immobilized thereon antibodies that react exclusively to the specimen, so that the specimen is captured on the surfaces of the fine particles.

Then, the test solution, containing unreacting part of the specimen, is washed out of the chip using a buffer solution.

Then, a solution containing an antibody attached with an enzyme serving as a sign is introduced through the introducing aperture 604 in order to form, on the fine particle surfaces, composites made of the antibody, specimen, and enzyme sign-attached antibody, which are immobilized on the fine particles 605.

Then, unreacting part of the enzyme sign-attached antibody is washed out of the chip using a buffer solution.

Then, a substrate material that is changed into an electrically active substance by the enzyme is introduced through the introducing aperture 604, and the electrode 613 measures the amount of the electrically active substance, which has been thus changed by an enzyme reaction on the surfaces of the fine particles 605. This enables it to know the amount of the specimen in the test solution.

The electrode 613 is formed on a channel wall surface as shown in, for example, FIG. 33(b). For the electrode and wiring to the electrode, techniques recited in Japanese Patent Application Publication Nos. 1-272958 and 2001-153838 (referred to as patent documents 3 and 4, respectively) may be used.

### SUMMARY OF THE INVENTION

As a result of various studies on analytical devices with microchannels, the present inventors have founded the following problems.

(1) Analytical microdevices with channels filled with reaction fine particles have reaction substances immobilized on the surface of the fine particles, thereby providing the advantage of increasing the reactable area. In order to make use of this advantage, the test solution needs to flow through the gaps between the fine particles. This is because causing the test solution to flow through the gaps between the fine particles provides increased chances of contact between the antigen contained in the test solution and the antibody immobilized on the surfaces of the fine particles. It is only by the test solution flowing in this manner that the efficiency of the antibody-antigen reaction can be improved.

However, in the conventional microdevice, which has such a structure that the damming portion 620 dams the fine particles 605, a space 611 is formed between a channel wall 610 and the fine particles 605, as schematically shown in FIG. 34. This causes much of the test solution to flow through the space 611, where there is no meandering and small resistance against flow, rather than through the small gaps between the fine particles 605. This reduces the amount of the antigen to react to the antibody immobilized on the surfaces of the fine particles, which is equivalent to the case of using a test solution with a thinner antigen than the originally intended density. Thus, the conventional microdevice cannot sufficiently improve its detection sensitivity.

To overcome the problem, densely filing the channel with fine particles to avoid occurrence of spaces appears to be effective. This, however, is to no avail, because a lower part of the channel 609 has larger resistance against the flow of the test solution while an upper part of the channel 609 has smaller flow resistance, which likewise causes much of the test solution to flow through the upper part of the fine particles 605 (upper part of FIG. 34), where the flow resistance is smaller.

(2) Such analytical microdevices are known that immobilize the antibody on the channel surfaces themselves. However, because fluid has a tendency to flow in inward regions somewhat distanced from the channel surfaces, much of the test solution does not come in contact with the antibody-immobilized surfaces. Thus, immobilizing the antibody on the channel surfaces poses problems similar to the foregoing.

(3) Methods for detection by analytical microdevices use, for example, fluorescent dyes, thermal lenses, radioactive isotopes, and electrochemical techniques. The electrochemical detection, among the foregoing, is superior in detection sensitivity and has high reproductivity. Referring to FIGS. 33 and 37(b), a conventional microdevice employing the electrochemical detection has an electrode 613 is formed in parallel to the flow direction. In this structure, however, the electrode itself has no force of attracting an electrically active substance resulting from an enzyme reaction. Thus, for the same reason as that described above, much of the electrically active substance contained in the test solution passes through regions distanced from the electrode surface, so that only part of the electrically active substance comes into contact with the electrode surface, where an oxidation-reduction reaction occurs. Thus, sufficient detection sensitivity cannot be provided.

In view of the foregoing and other problems, it is an object of the present invention to provide an analytical microchannel device superior in detection sensitivity.

In order to improve the reaction efficiency between the specimen contained in the test solution and antibodies and the like, and in order to improve the detection sensitivity of the electrode dedicated to electrochemical detection, the present invention has employed means to substantially vertically bend the flow of the test solution.

The present invention consists of four invention groups, with a first invention group drawn to reaction, a second invention group drawn to detection, a third invention group drawn to a combination of the first two groups, and a fourth invention group drawn to the structure such that a reaction substance that reacts exclusively to a specimen contained in the test solution is disposed on a surface of an electrochemical detection-dedicated electrode. The invention groups will be described below in sequence.

(First Invention Group)

According to a first aspect of the first invention group, an analytical microchannel device includes: a first channel through which a test solution flows; a second channel substantially parallel to the first channel; and a third channel substantially vertically connecting the first channel and the second channel to one another. In the vicinity of an inlet of the third channel, the first channel holds therein fine particles to prevent drainage thereof toward a lower stream side. Each of the fine particles has a reaction substance reacting exclusively to a specimen contained in the test solution.

In this structure, as shown in FIG. 3, when the test solution flows from a first channel 8 through a third channel 15 to a second channel 10, a substantially vertically bent flow is created as indicated by arrows 20. This enables fine particles 14 to uniformly react to the specimen contained in the test solution, thus providing improvement in reaction efficiency. As a result, detection sensitivity is improved.

According to a second aspect of the first invention group, an analytical microchannel device includes: a first channel through which a test solution flows; a second channel substantially parallel to the first channel; a plurality of third channels substantially vertically connecting the first channel and the second channel to one another. A reaction substance-holding portion is disposed in each of inter-inlet regions of the plurality of third channels that is located on a floor surface of the first channel. The reaction substance-holding portion is composed of a reaction substance reacting exclusively to a specimen contained in the test solution. The reaction substance is immobilized in the inter-inlet regions.

In this structure, as shown in FIG. 4, when the test solution flows from the first channel 8 through the third channels 15 to the second channel 10, a substantially vertically bent flow is created as indicated by arrows 20. This enables the immobilizing reaction substance constituting a reaction substance-holding portion 16 to uniformly react to the specimen contained in the test solution, thus providing improvement in reaction efficiency. As a result, detection sensitivity is improved.

While the term floor surface, as used herein, refers to the bottom surface of the channel, because the analytical microchannel device can be used in any orientation, any surface of the channel can be assumed the floor surface depending on how the device is oriented. The reaction substance-holding portion as used herein refers to a sum of the portion between the inlet of a channel and the inlet of an adjacent channel, the portion between the inlet of the adjacent channel and the inlet of a channel located adjacent the adjacent channel, and so forth (see reference numeral 11 in FIG. 4(c)).

According to a third aspect of the first invention group, an analytical microchannel device includes: a first channel through which a test solution flows; a second channel substantially parallel to the first channel; and a third channel substantially vertically connecting the first channel and the second channel to one another. The third channel has a filter substantially parallel to the first channel. The filter has a reaction substance immobilized on a surface against the first channel. The reaction substance reacts exclusively to a specimen contained in the test solution.

According to a fourth aspect of the first invention group, an analytical microchannel device includes: a first channel through which a test solution flows; a second channel substantially parallel to the first channel; a flow veering means for substantially vertically bending flow of the test solution through the first channel toward the second channel; a filter in the vicinity of the flow veering means and in a region between the first channel and the second channel. The filter is substantially parallel to the first channel. A reaction substance is immobilized on a surface of the filter against the first channel. The reaction substance reacts exclusively to a specimen contained in the test solution.

These structures provide similar advantageous effects to those provided by the second aspect of the first invention group.

In the above structures, if the channels are excessively large in diameter or if the mesh of the filter is excessively large, then an increased amount of the specimen passes through a portion without the reaction substance. That is, the amount of the specimen that does not react to the reaction substance increases. On the other hand, if the channels are excessively small in diameter, fluid cannot easily flow through the channels, resulting in an excessively small flow rate. In view of this, the channel diameter and the mesh are preferably 1 μm to 100 μm.

Instead of vertically bending the solution flow, a filter may be disposed across a straight channel. However, for a channel on a micro-scale, only a filter with a size equal to or less than the diameter of the channel is available. The excessively small filter area makes the required solution sending pressure excessively large, providing a possibility of device rupture. Contrarily, as in the present invention, providing a filter between two parallel channels allows for an enlarged filter area, thus eliminating the foregoing problem. In view of this, the area of the filter and the cross sectional area of the third channel (in the case of a plurality of third channels, the total of the cross sectional areas) are preferably 10³ μm² to 10⁷ μm², more preferably 10⁴ μm² to 10⁶ μm².

In the fourth aspect of the first invention group, the flow veering means is defined by a wall provided at an end of the first channel on a lower stream side. The wall is substantially vertical to the first channel. This facilitates fabrication of the device.

In the first aspect of the first invention group, the third channel may include a plurality of fine channels each having a diameter smaller than a diameter of each of the fine particles. Drainage of the fine particles is prevented by the plurality of fine channels.

Prevention of drainage of the fine particles out of the reaction substance-holding portion can be carried out by providing the fine particles with a magnetic property while disposing a magnet in the exterior. Still, the above claimed structure is preferred for simplicity of the device.

The third channel may be shaped in various ways as indicated by reference numeral 15 in FIGS. 18(a) to 18(e), insofar as the fine particles cannot pass through the channel. This necessitates that the smallest diameter of the channel be at least smaller than the diameter of a largest one of the fine particles. Preferably, the smallest diameter of the channel is smaller than the diameter of a smallest one of the fine particles. It is possible, however, that the largest diameter of the channel is larger than the diameter of the largest one of the fine particles.

In the first to third aspects of the first invention group, the analytical microchannel device may include a first substrate having a groove constituting the first channel, a second substrate having a groove constituting the second channel, and a third substrate having a through aperture for the third channel. The first substrate, the third substrate, and the second substrate are stacked atop each other in this order. This structure facilitates fabrication of the analytical microchannel device of each of the first to third aspects of the first invention group.

In the fourth aspect of the first invention group, the analytical microchannel device may include a first substrate having a groove constituting the first channel, a second substrate having a groove constituting the second channel, and a filter. The first substrate, the filter, and the second substrate are stacked atop each other in this order. This structure facilitates fabrication of the analytical microchannel device of the fourth aspect of the first invention group.

These structures, when employed in the second to fourth aspect of the first invention group, provide the advantage of reusability of the analytical microchannel device; when the reaction substance is degraded, the structures can be dislaminated to replace the third substrate or the filter.

The analytical microchannel device of the first aspect of the first invention group is also reusable by, when the reaction substance is degraded, reversing the solution flow, i.e., toward the first channel from the second channel, to wash away the fine particles along with the solution and by re-injecting fine particles.

(Second Invention Group)

According to a first aspect of the second invention group, an analytical microchannel device includes: a channel A through which a test solution flows; a channel B substantially parallel to the channel A; a channel C substantially vertically connecting the channel A and the channel B to one another; and an electrochemical detection-dedicated electrode disposed on a floor surface of a portion of the channel B, the portion being immediately under the channel C and meeting the channel C at a substantially right angle.

It should be noted that the channels A, B, and C respectively correspond to the first, second, and third channels of the first invention group.

According to a second aspect of the second invention group, an analytical microchannel device includes: a channel A through which a test solution flows; a channel B substantially parallel to the channel A; a plurality of channels C substantially vertically connecting the channel A and the channel B to one another; and an electrochemical detection-dedicated electrode disposed in each of inter-inlet regions of the plurality of channels C that is located on a floor surface of the channel A.

According to a third aspect of the second invention group, an analytical microchannel device includes: a channel A through which a test solution flows; a channel B substantially parallel to the channel A; a flow veering means for substantially vertically bending flow of the test solution through the channel A toward the channel B; and an electrochemical detection-dedicated electrode disposed immediately under the flow veering means and on a floor surface of the channel B.

According to the second invention group, as shown in FIGS. 6(b), 7(b), 8(b), and 9(b), a test solution containing an electrically active substance comes in contact with an electrochemical detection-dedicated electrode 13 in a substantially vertical manner. This causes substantially all of the electrically active substance contained in the test solution to come in contact with the electrochemical detection-dedicated electrode 13, resulting in a significant improvement in detection sensitivity.

In the first aspect of the second invention group, the channel C may include a plurality of channels. This more firmly secures the contact of the electrically active substance against the electrochemical detection-dedicated electrode 13.

In the first aspect of the second invention group, the analytical microchannel device may include: a substrate a having a groove constituting the channel A, a substrate b having a groove constituting the channel B and having formed thereon the electrochemical detection-dedicated electrode, and a substrate c having a through aperture for the channel C. The substrate a, the substrate c, and the substrate b are stacked atop each other in this order. This structure facilitates fabrication of the analytical microchannel device of the first aspect of the second invention group.

Placing a wire connected to the electrode on a substrate with an uneven channel may occasionally be difficult from fabricational viewpoints. In this case, the substrate b is preferably composed of two layers, a substrate b1 having formed thereon the channel B and a substrate b2 having formed thereon the electrochemical detection-dedicated electrode.

In the second aspect of the second invention group, the analytical microchannel device may include: a substrate a having a groove constituting the channel A, a substrate b having a groove constituting the channel B, and a substrate c having a through aperture for the channel C and having formed thereon the electrochemical detection-dedicated electrode. The substrate a, the substrate c, and the substrate b are stacked atop each other in this order. This structure facilitates fabrication of the analytical microchannel device of the second aspect of the second invention group. Also in this structure the electrode is mounted on the planer substrate, which eliminates the need for the two layer structure for the substrate c.

In the third aspect of the second invention group, the analytical microchannel device may include: a substrate a having a groove constituting the channel A, and a substrate b having a groove constituting the channel B and having formed thereon the electrochemical detection-dedicated electrode. The substrate a and the substrate b are stacked atop one another. This structure facilitates fabrication of the analytical microchannel device of the third aspect of the second invention group.

Also in this case, the substrate b may be composed of two layers, a substrate b1 having formed thereon the channel B and a substrate b2 having formed thereon the electrochemical detection-dedicated electrode.

(Third Invention Group)

According to a first aspect of the third invention group, the electrochemical detection-dedicated electrode of each of the first to third aspects of the first invention group is disposed on a floor surface of a portion of the second channel that is immediately under the third channel and meets the third channel at a substantially right angle.

According to a second aspect of the third invention group, the electrochemical detection-dedicated electrode of the fourth aspect of the first invention group is disposed on a portion of the floor surface of the second channel that is immediately under the filter.

According to a third aspect of the third invention group, the analytical microchannel device of each of the first to third aspects of the first invention group may further include a fourth channel substantially parallel to the second channel; a fifth channel substantially vertically connecting the second channel and the fourth channel to one another. An electrochemical detection-dedicated electrode is disposed on a floor surface of a portion of the fourth channel that is immediately under the fifth channel and meets the fifth channel at a substantially right angle.

According to a fourth aspect of the third invention group, the analytical microchannel device of each of the first to third aspects of the first invention group may further include: a fourth channel substantially parallel to the second channel; a plurality of fifth channels substantially vertically connecting the second channel and the fourth channel to one another. An electrochemical detection-dedicated electrode is disposed in each of inter-inlet regions of the plurality of fifth channels that is located on a floor surface of the second channel.

The third invention group provides the advantageous effects of the first invention group and those of the second invention group at the same time. These advantageous effects synergistically combine to further improve detection sensitivity.

In the first aspect of the third invention group, the analytical microchannel device may include a first substrate having a groove constituting the first channel, a second substrate having a groove constituting the second channel and having formed thereon the electrochemical detection-dedicated electrode, and a third substrate having a through aperture for the third channel. The first substrate, the third substrate, and the second substrate are stacked atop each other in this order. This structure facilitates fabrication of the analytical microchannel device of the first aspect of the third invention group.

In the second aspect of the third invention group, the analytical microchannel device may include a first substrate having a groove constituting the first channel, a second substrate having a groove constituting the second channel and having formed thereon the electrochemical detection-dedicated electrode, and a filter. The first substrate, the filter, and the second substrate are stacked atop each other in this order. This structure facilitates fabrication of the analytical microchannel device of the second aspect of the third invention group.

As described above, placing a wire connected to the electrode on a substrate with an uneven channel may occasionally be difficult from fabricational viewpoints. In this case, the second substrate is preferably composed of two layers, a second substrate a having formed thereon the second channel and a second substrate b having formed thereon the electrochemical detection-dedicated electrode.

In the third aspect of the third invention group, the analytical microchannel device may further include; a first substrate having a groove for the first channel and a groove for the fourth groove, and having formed thereon the electrochemical detection-dedicated electrode; a second substrate having a groove for the second channel; and a third substrate having a through aperture for the third channel and a through aperture for the fifth channel. The first substrate, the third substrate, and the second substrate are stacked atop each other in this order. This structure facilitates fabrication of the analytical microchannel device of the third aspect of the third invention group.

Also in this case, the first substrate may be composed of two layers, a first substrate 1a having a groove for the first channel and a groove for the fourth groove, and a first substrate 1b having formed thereon the electrochemical detection-dedicated electrode.

In the fourth aspect of the third invention group, the analytical microchannel device may further include; a first substrate having a groove for the first channel and a groove for the fourth groove; a second substrate having a groove for the second channel; and a third substrate having a through aperture for the third channel and a through aperture for the fifth channel, and having formed thereon the electrochemical detection-dedicated electrode. The first substrate, the third substrate, and the second substrate are stacked atop each other in this order. This structure facilitates fabrication of the analytical microchannel device of the fourth aspect of the third invention group.

(Fourth Invention Group)

According to the fourth invention group, an analytical microchannel device has the electrochemical detection-dedicated electrode according to the second invention group such that a substance that reacts exclusively to the specimen contained in the test solution is disposed on a surface of the electrochemical detection-dedicated electrode. Thus, the structure of the analytical microchannel device according to the fourth invention group is such that in each invention of the second invention group, a substance that reacts exclusively to the specimen contained in the test solution is disposed on a surface of the electrochemical detection-dedicated electrode.

In the conventional channel device, the electrochemical detection-dedicated electrode has been parallel to the flow of the test solution in order to avoid interference of the test solution flow. Meanwhile, any of the electrochemical detection-dedicated electrodes according to the second invention group is disposed in a position where the test solution flowing through the channel device hits the electrode at a substantially right angle. This structure causes the specimen contained in the test solution to efficiently come into contact with the reaction substance provided on the electrode surface, thus providing improvement in reaction efficiency. As a result, detection sensitivity is improved.

For example, when the specimen contained in the test solution is assumed to be an antigen material, and the reaction substance that reacts exclusively to the specimen contained in the test solution is assumed to be an antibody material, then the antigen material contained in the test solution hits the electrode surface at a substantially right angle, thus meeting the antibody material efficiently. The same applies to the case of using an antibody material attached with an enzyme serving as a sign, thus effectively forming on the electrode surface of the above channel device a composite of antibody material, antigen material, and enzyme sign-attached antibody material. Further, when, after formation of the composite, a substrate material that is changed to an electrically active substance by the enzyme of the enzyme sign-attached antibody material is allowed to flow, then the substrate material efficiently reacts to the enzyme on the electrode surface, thereby generating more of the electrically active substance. Thus, the above structure provides the advantages effect of improving detection sensitivity, which is realized because of generation of larger current.

### BRIEF DESCRIPTION OF THE DRAWINGS

FIG. 1 is a plan view of an analytical microchannel device according to embodiment 1-1.

FIG. 2 is a cross sectional view of the analytical microchannel device according to embodiment 1-1.

FIG. 3 is a diagram schematically showing the solution flow in the analytical microchannel device according to embodiment 1-1.

FIG. 4(a) is a cross sectional view of an analytical microchannel device according to embodiment 1-2; FIG. 4(b) is a diagram schematically showing the solution flow in the analytical microchannel device; and FIG. 4(c) is a plan view of the third substrate.

FIG. 5 is a diagram schematically showing the solution flow in an analytical microchannel device according to embodiment 1-4.

FIG. 6(a) is a cross sectional view of an analytical microchannel device according to embodiment 2-1; and FIG. 6(b) is a diagram schematically showing the solution flow in the analytical microchannel device.

FIG. 7(a) is a cross sectional view of an analytical microchannel device according to embodiment 2-2; and FIG. 7(b) is a diagram schematically showing the solution flow in the analytical microchannel device.

FIG. 8(a) is a cross sectional view of an analytical microchannel device according to embodiment 2-3; and FIG. 8(b) is a diagram schematically showing the solution flow in the analytical microchannel device.

FIG. 9(a) is a cross sectional view of an analytical microchannel device according to embodiment 2-3; and FIG. 9(b) is a diagram schematically showing the solution flow in the analytical microchannel device.

FIG. 10 is a cross sectional view of an analytical microchannel device according to embodiment 3-1.

FIG. 11 is a cross sectional view of an analytical microchannel device according to embodiment 3-2.

FIG. 12 is a cross sectional view of an analytical microchannel device according to embodiment 3-3.

FIG. 13 is a cross sectional view of an analytical microchannel device according to embodiment 3-4.

FIG. 14 is a cross sectional view of an analytical microchannel device according to embodiment 3-5.

FIG. 15 is a cross sectional view of an analytical microchannel device according to embodiment 3-6.

FIG. 16 is a cross sectional view of the analytical microchannel device of any of the embodiments for showing a modified example of a channel.

FIG. 17 is another cross sectional view of the analytical microchannel device of any of the embodiments for showing a modified example of a channel.

FIG. 18 is a diagram showing examples the third channel (fine aperture) of the analytical microchannel device according to the present invention.

FIG. 19 is a diagram for illustrating the shape of a filter of the analytical microchannel device according to the present invention.

FIG. 20(a) is a cross sectional view of an analytical microchannel device according to embodiment 4-1; and FIG. 20(b) is a diagram schematically showing the solution flow in the analytical microchannel device.

FIG. 21(a) is a cross sectional view of an analytical microchannel device according to embodiment 4-2; and FIG. 21(b) is a diagram schematically showing the solution flow in the analytical microchannel device.

FIG. 22(a) is a cross sectional view of an analytical microchannel device according to embodiment 4-3; and FIG. 22(b) is a diagram schematically showing the solution flow in the analytical microchannel device.

FIG. 23(a) is a cross sectional view of an analytical microchannel device according to embodiment 4-4; and FIG. 23(b) is a diagram schematically showing the solution flow in the analytical microchannel device.

FIG. 24 is a diagram for illustrating the process of fabricating a first substrate of an analytical microchannel device according to example 1.

FIG. 25 is a diagram for illustrating the process of fabricating a second substrate of an analytical microchannel device according to example 1.

FIG. 26 is a diagram for illustrating the process of fabricating a third substrate of an analytical microchannel device according to example 1.

FIG. 27 is a diagram for illustrating an analytical microchannel device according to example 1.

FIG. 28 is a diagram for illustrating an analytical microchannel device according to example 2.

FIG. 29 is a diagram for illustrating an analytical microchannel device according to example 3.

FIG. 30 is a diagram for illustrating the process of fabricating a first substrate of an analytical microchannel device according to example 3.

FIG. 31 is a cross sectional view of a second substrate of an analytical microchannel device according to example 3.

FIG. 32 is a plan view of a third substrate of an analytical microchannel device according to example 3 and an electrochemical detection-dedicated electrode disposed on the third substrate.

FIG. 33(a) is a plan view of an analytical microchannel device according to comparative example 1; and FIG. 33(b) is a cross sectional view of the device.

FIG. 34 is a partially enlarged cross sectional view of the analytical microchannel device according to comparative example 1.

FIG. 35 is a cross sectional view of an analytical microchannel device according to comparative example 2.

FIG. 36 is a cross sectional view of an analytical microchannel device according to comparative example 3.

FIG. 37 is a diagram showing the solution flow in relation to the electrode surface of a conventional analytical microchannel device.

### DESCRIPTION OF THE PREFERRED EMBODIMENTS

The preferred embodiments of the present invention will be described. The embodiments described below are divided into first to fourth embodiment groups respectively drawn to: an analytical microchannel device that substantially vertically bends the flow of solution at a reaction substance-immobilized region; an analytical microchannel device that substantially vertically bends the flow of solution that comes into contact with the electrochemical detection-dedicated electrode; a combination of the first and second groups; and an analytical microchannel device that has a reaction substance that reacts exclusively to a specimen contained in the test solution provided on a surface of the electrochemical detection-dedicated electrode. The description below will be with reference to these embodiment groups in conjunction with the drawings.

### First Embodiment Group

### Embodiment 1-1

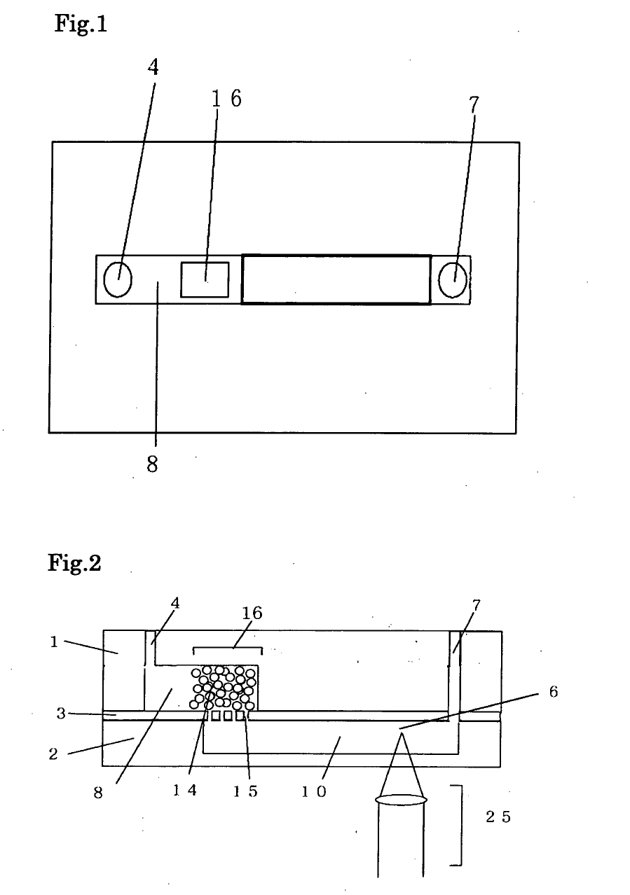

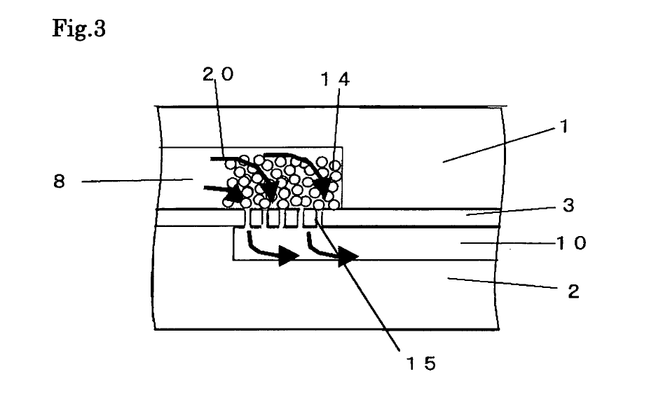

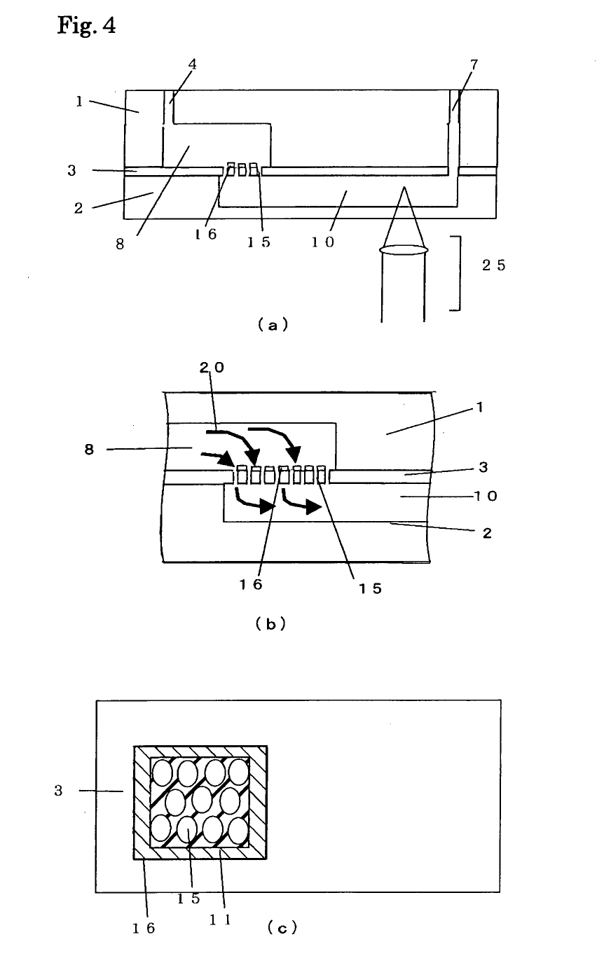

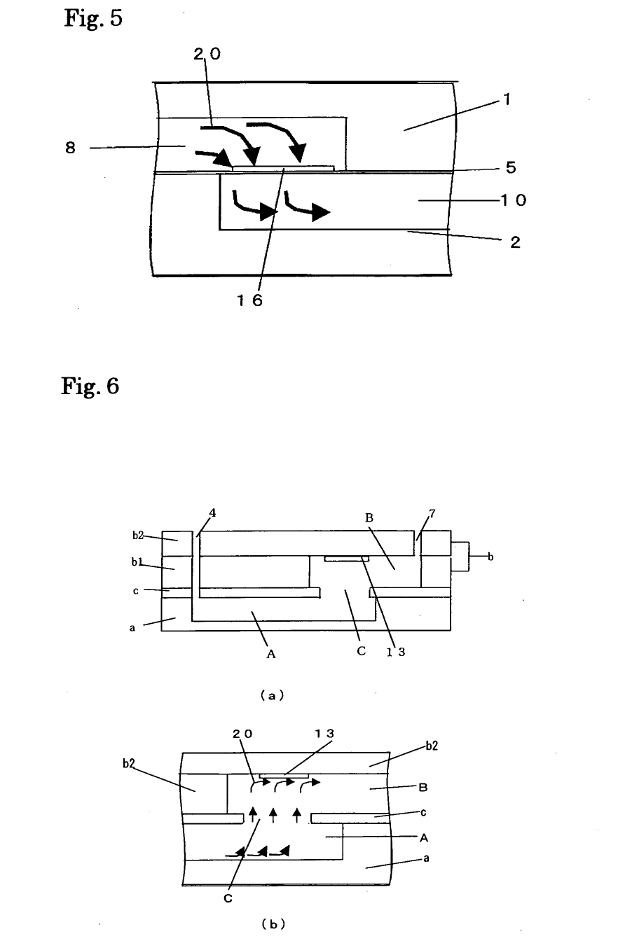

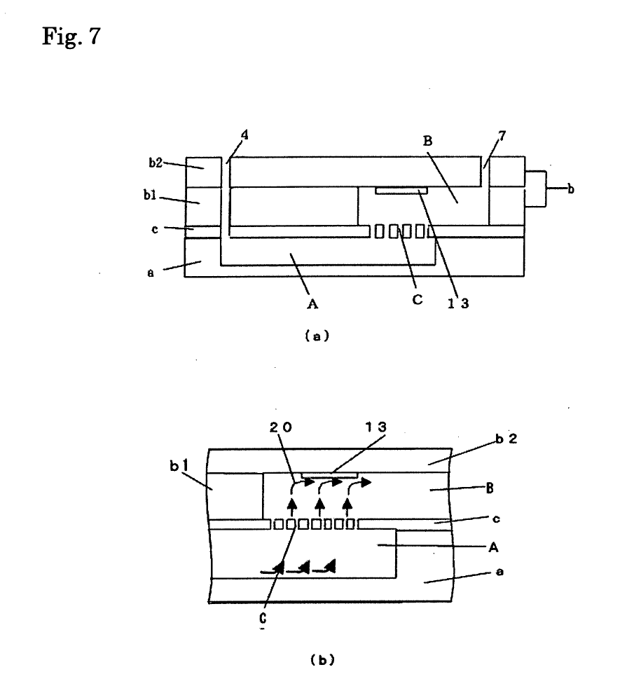

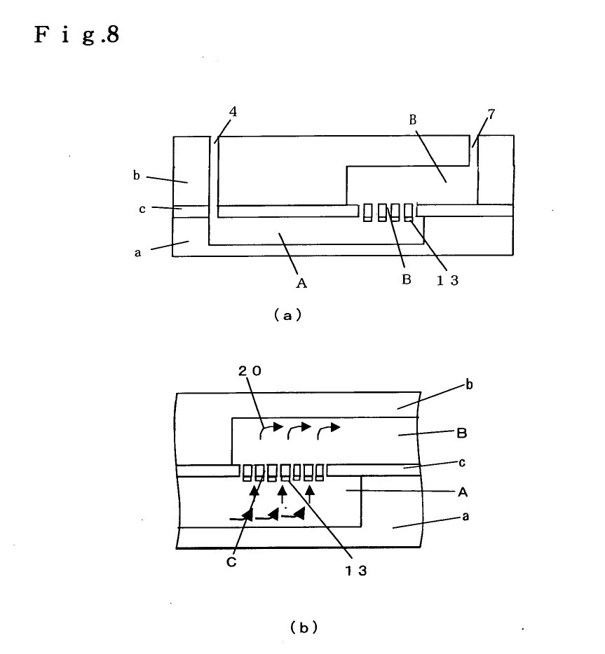

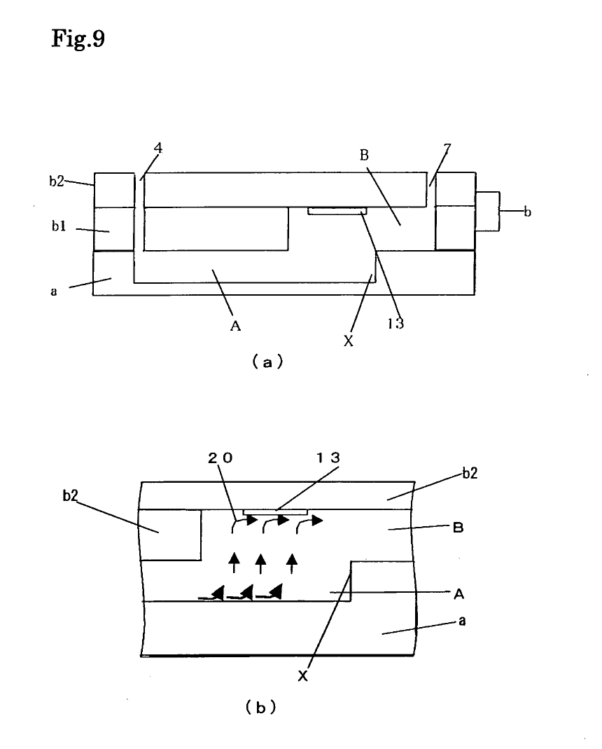

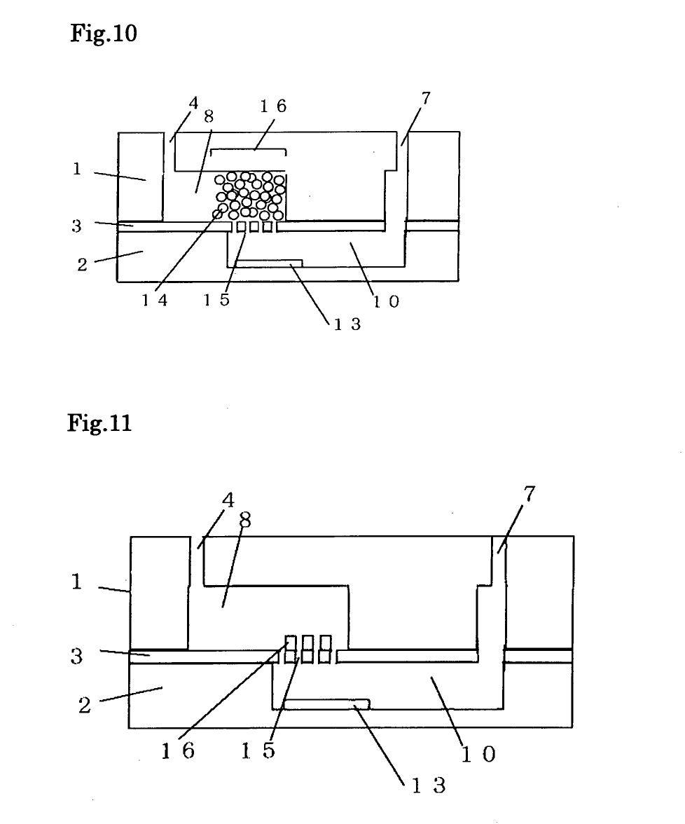

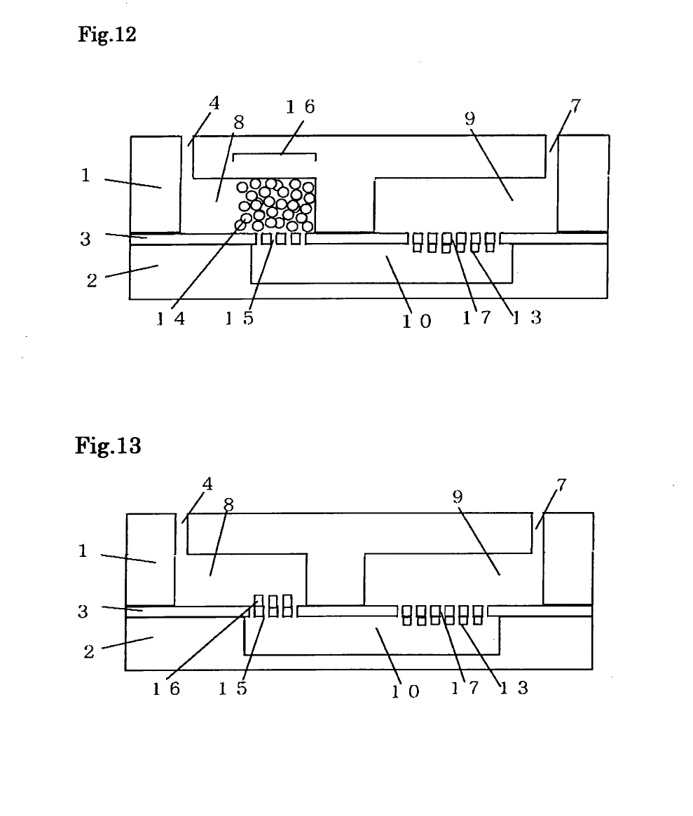

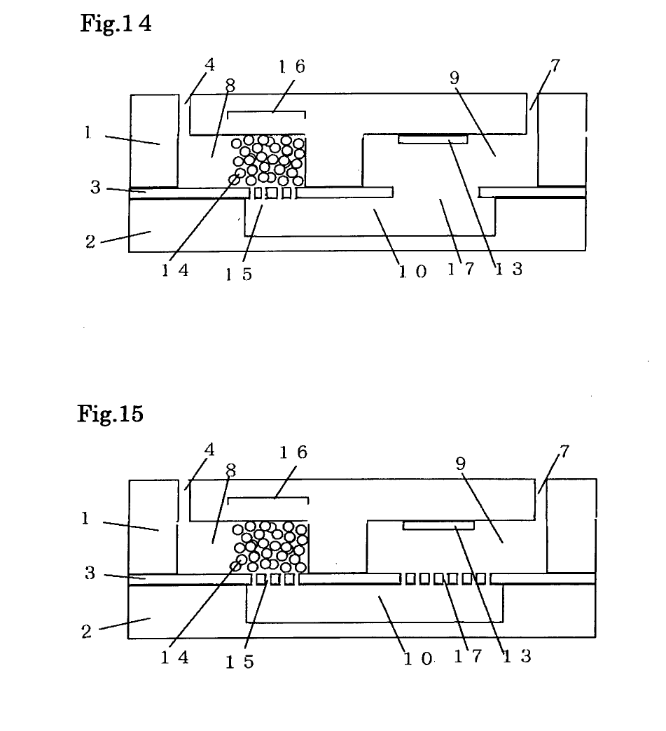

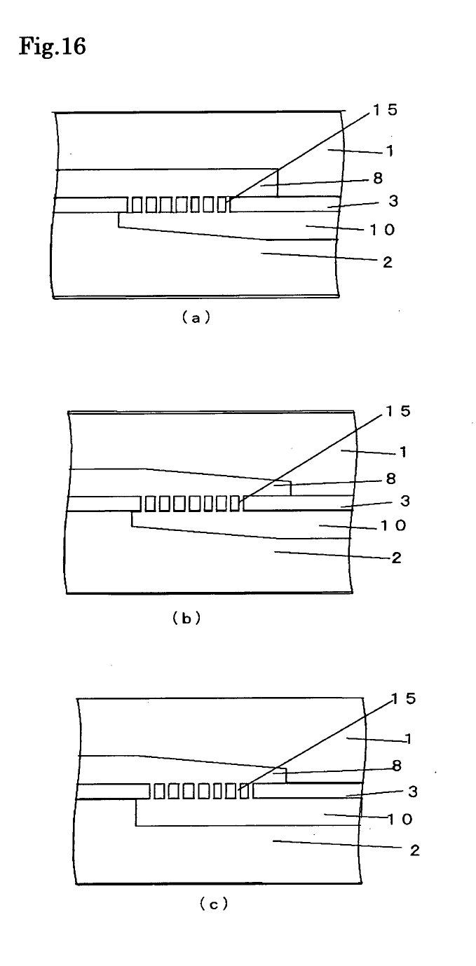

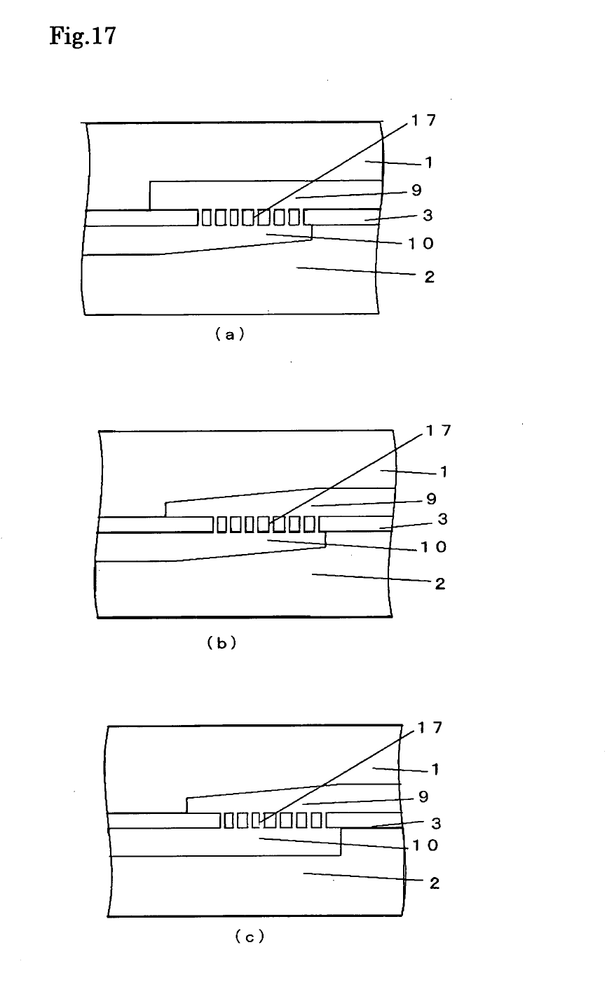

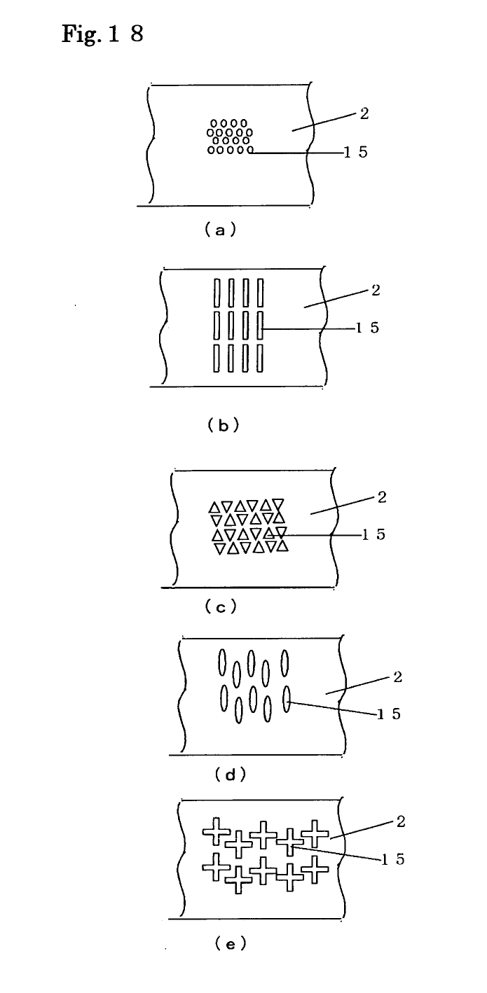

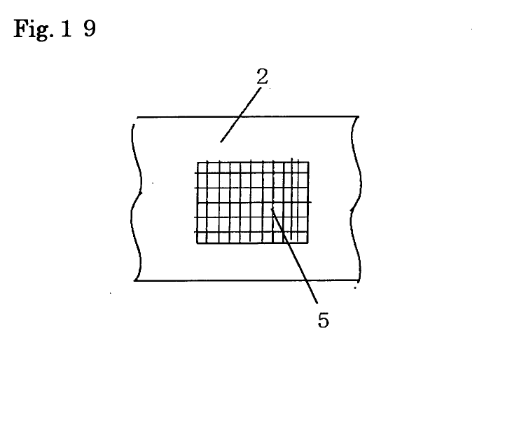

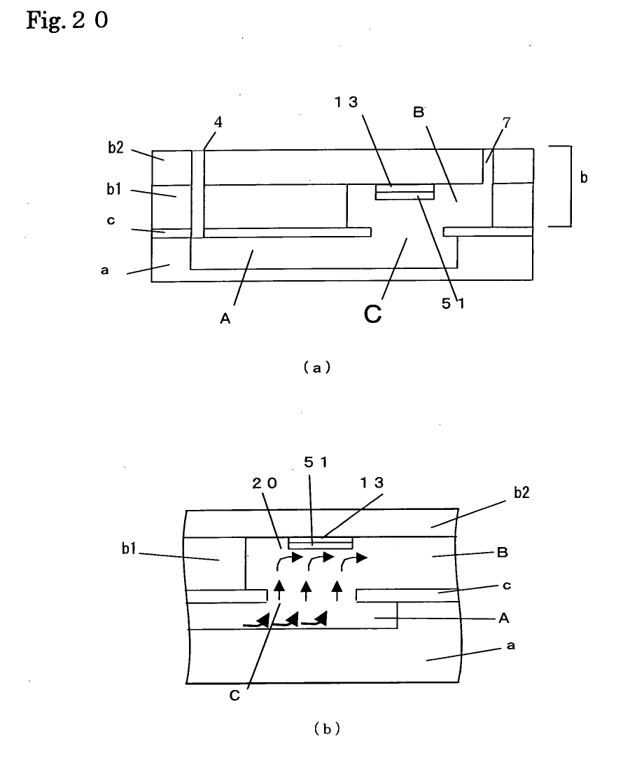

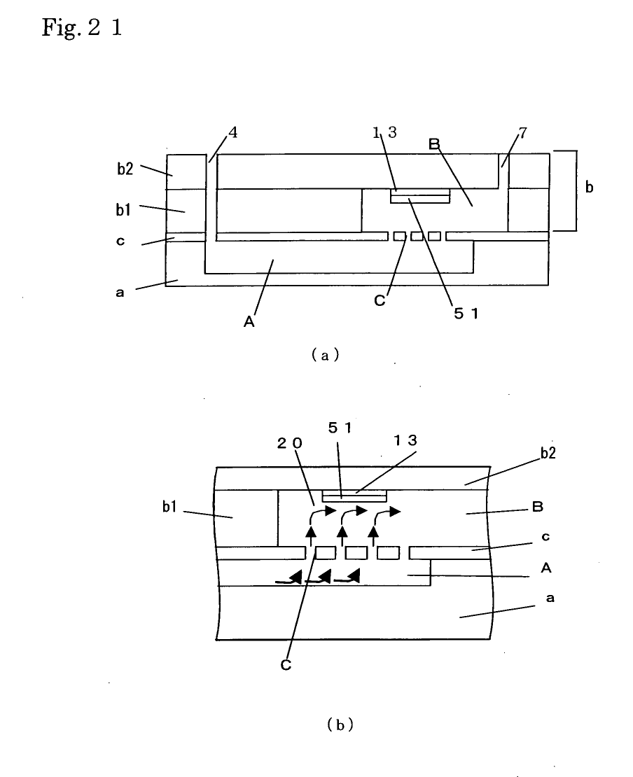

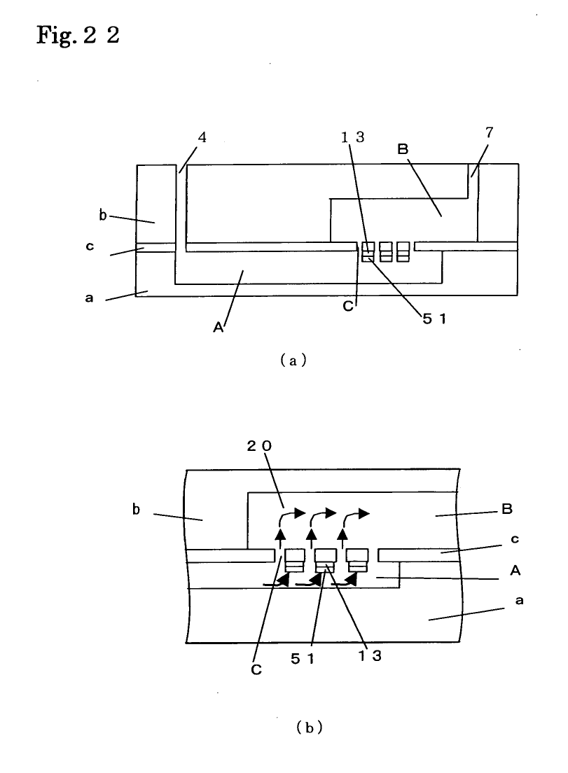

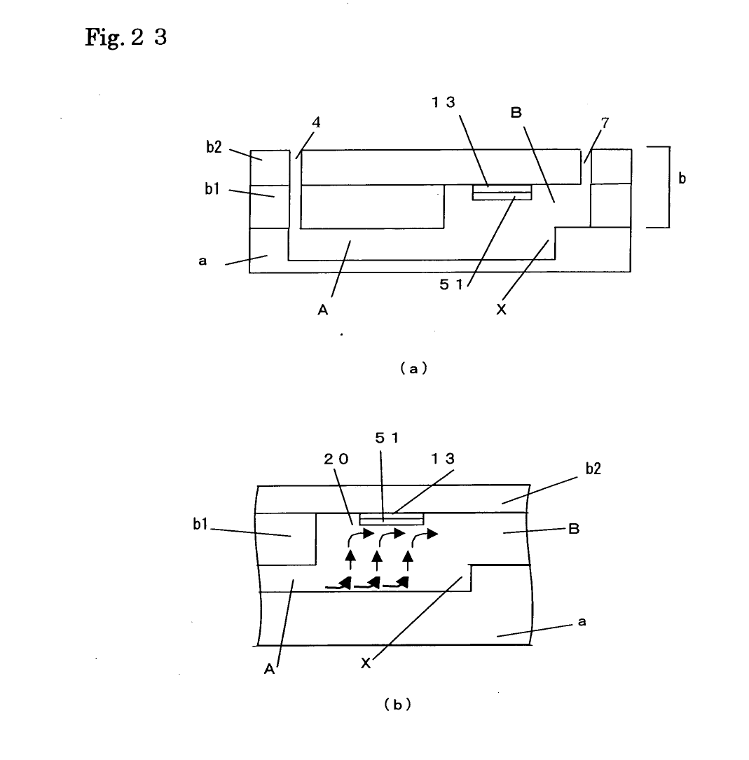

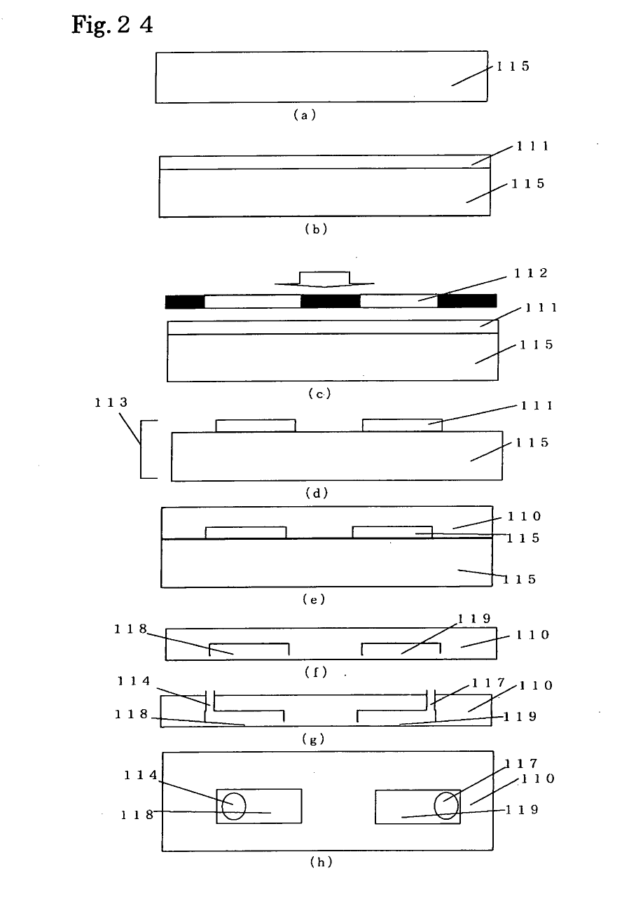

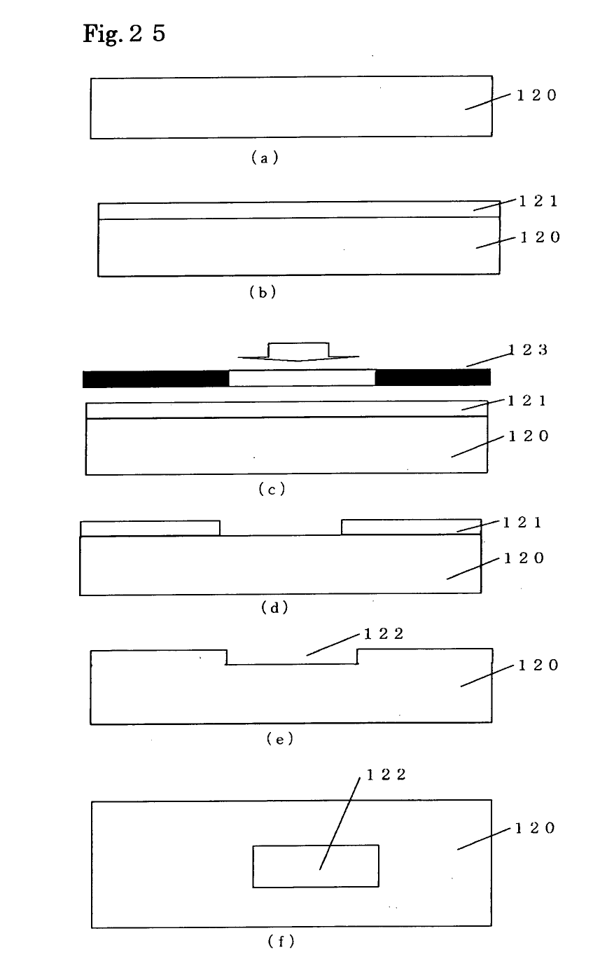

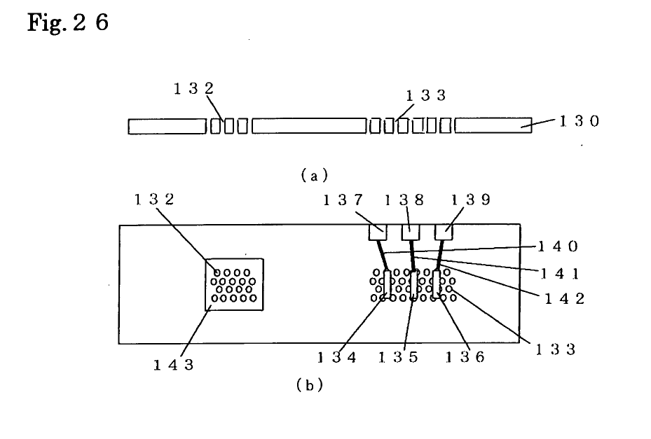

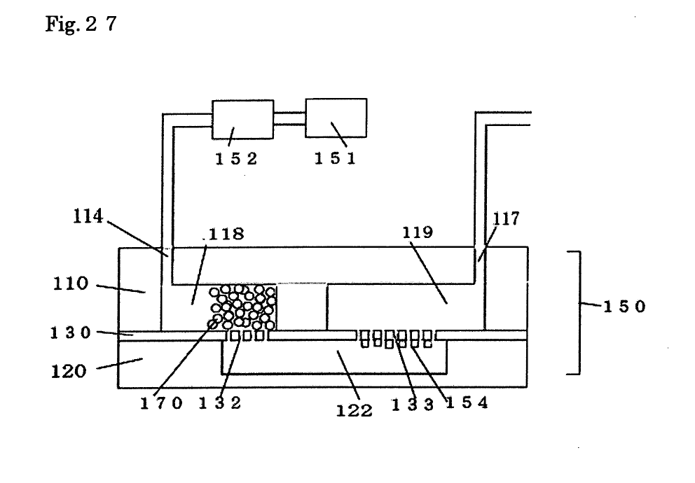

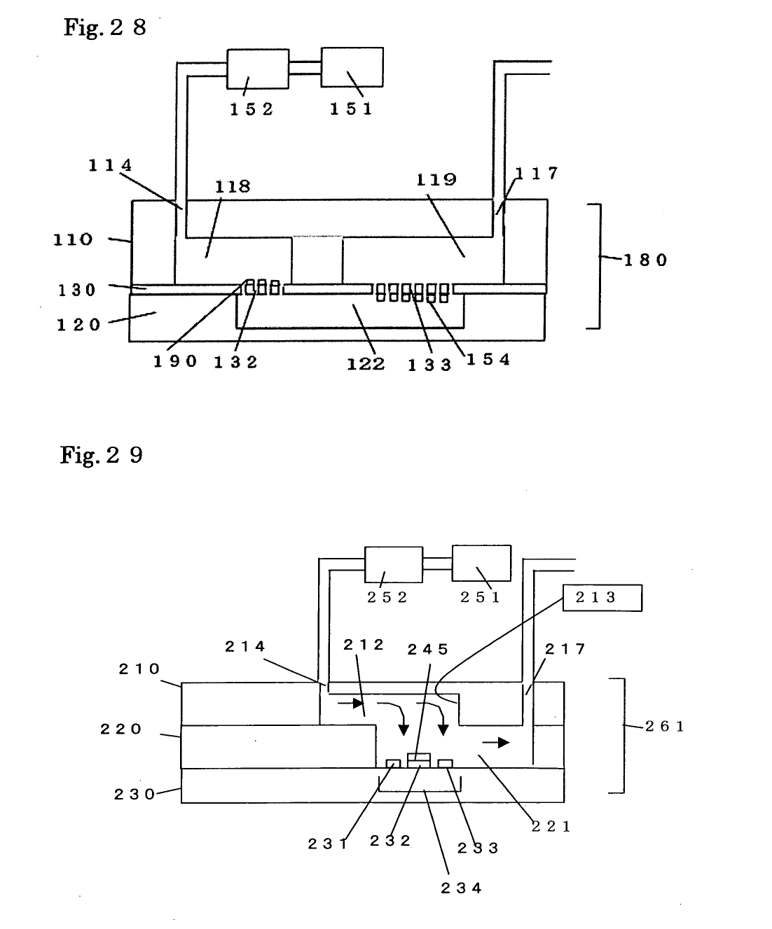

FIG. 1 is a plan view of a microchannel device (microdevice) according to this embodiment, and FIG. 2 is a cross sectional view of the microdevice according to this embodiment. The microdevice includes a first channel 8, a second channel 10 that is parallel to the first channel 8, and a third channel 15 that vertically connects the first and second channels to one another. On an upper stream-side end portion of the first channel 8 is formed an introducing aperture 4 through which a test solution, buffer solution (e.g., phosphoric acid buffer solution), and the like are injected into the microdevice. On a lower stream-side end portion of the second channel 10 is formed a discharging aperture 7 through which the test solution, buffer solution, and the like are discharged out of the microdevice. In the vicinity of an inlet of the third channel 15, the first channel 8 has therein a reaction substance-holding portion 16 that holds and prevents drainage of fine particles 14 each having immobilized thereon a reaction substance that reacts exclusively to a specimen contained in the test solution. The second channel 10 has a detecting portion 6 that detects the amount of the specimen contained in the test solution.

Referring to FIG. 2, the microdevice has a lamination structure of three substrates 1 to 3. The first substrate 1 has the introducing aperture 4, the first channel 8, and the discharging aperture 7. The reaction substance-holding portion 16 is formed in the first channel 8 in the vicinity of the inlet of the third channel 15, and holds the fine particles 14 so as to prevent drainage thereof. The thickness of the first substrate 1 is preferably 0.1 mm to 5 mm.

The shape of each of the introducing aperture 4 and the discharging aperture 7 is not particularly specified; any shape is contemplated including a circle, ellipse, polygon, and indeterminate shape. The size of each shape is approximately equal to or more than 1 μm in diameter.

The first channel 8 is 1 μm to 1 mm in width and 1 μm to 1 mm in depth. The cross sectional shape of the first channel 8 is not particularly specified; any cross section is contemplated including a quadrangle, trapezoid, and semicircle.

For the solid fine particles, glass, plastic, and the like may be used. Magnetic particles may also be used. For the reaction substance, any substance may be used insofar as they react exclusively to and capture the specimen. Examples include antibody materials such as a monoclonal antigen and polyclonal antigen, and what are called artificial antigen materials such as an imprinting polymer, aptamer material, and peptide material.

The second substrate 2 has the second channel 10, which is parallel to the first channel 8, which is formed in the first substrate 1. Part of the upper-stream end of the second channel 10 and part of the lower-stream end of the first channel 8 overlap in the manner shown in FIG. 2. The thickness of the second substrate 2 is preferably approximately 0.1 mm to 5 mm. The second channel 10 is 1 μm to 1 mm in width and 1 μm to 1 mm in depth. The cross sectional shape of the second channel 10 is not particularly specified; any cross section is contemplated including a quadrangle, trapezoid, and semicircle. The second channel 10 has therein the detecting portion 6, which detects the amount of the specimen.

The third substrate 3 has the third channel 15, which vertically connects the first channel 8 and the second channel 10 to one another. The third substrate 3 also has an aperture that provides communication between the second channel 10, which is formed in the second substrate 2, and the discharging aperture 7, which is formed in the first substrate 1.

While a magnetic material can be used for the fine particles 14 with an external magnet provided outside the first channel 8 in order to prevent drainage of the fine particles 14 out of the reaction substance-holding portion 16, drainage of the fine particles 14 is preferably prevented by providing the third channel 15 with a plurality of fine channels each having a diameter smaller than the fine particle, for a simpler device structure and a reduction in cost.

The detecting portion 6 is a place for detection, i.e., when, for example, an external thermal lens 25 carries out the detection, the detecting portion 6 need not be provided with special means, and preferably should not be provided with anything obstructive to the detection. For improved detection accuracy, the second channel 10 may be provided therein with solution stirring means for a uniform concentration of the solution when flowing past the detecting portion 6.

The fine channels of the third channel 15 may be in any shape such as a circle, square, triangle, ellipse, cross, and combination of the foregoing, as shown in FIG. 18. While the aperture shape and arrangement pattern are not particularly specified, a preferable internal aperture diameter (internal diameter of the channel) is in the range 0.1 μm to 0.1 mm. The third channel 15 may be composed of a single larger through aperture over which a filter 5 made of a fibrous network is placed, as shown in FIG. 19.

For the first and second substrates 1 and 2, glass, photo- and thermo-setting resin, thermo-setting resin, or the like may be used, examples of the resin material including polyolefin resin, polymethacrylic acid resin, and polycarbonate resin. For the third substrate 3, glass plastic material, silicon wafer, plastic films, metal film forming films, or the like are exemplified.

The first and second substrates 1 and 2 may be composed of glass on which a channel pattern is formed by, for example, etching, or each substrate and channel may be integrally formed by pouring a photo- and thermo-setting resin or thermo-setting resin into a mold with the channel pattern formed thereon, and curing the resin. For example, polyolefin resin, polymethacrylic acid resin, or polycarbonate resin may be subjected to hot embossing with the use of a mold with the channel pattern thereon.

The third substrate 3 may be composed of glass on which a pattern of a plurality of apertures is formed by, for example, etching, or the substrate and channel may be integrally formed by pouring a photo- and thermo-setting resin or thermo-setting resin into a mold with the channel pattern formed thereon, and curing the resin. Still alternatively, the third substrate 3 may be composed of a single larger through aperture over which a filter is placed.

The introducing aperture 4 may be in any form insofar as it is connected to the first channel 8 on the upstream side relative to the reaction substance-holding portion 16. The discharging aperture 7 may be formed in the second substrate 2.

The third substrate 3 may be eliminated while, instead, rendering the first substrate 1 a two layer structure composed of a first substrate 1a having formed thereon a groove constituting the first channel and a through aperture for the third channel and of a first substrate 1b serving as a lid for the first substrate 1a.

Description will now be made of detection of, for example, an antigen such as allergen with the use of the microdevice shown in FIGS. 1 and 2.

The channels 8 and 10, the reaction substance-holding portion 16, and the detecting portion 6 of the microdevice are filled with a buffer solution (e.g., phosphoric acid buffer solution) in advance. Next, through the introducing aperture 4 is injected a buffer solution with which to wash the interior of the microdevice. Then, through the introducing aperture 4 are injected a plurality of fine particles 14 each having immobilized thereon an antibody material along with a buffer solution. Preferably, an albumin aqueous solution is then allowed to flow to form an albumin film (nonspecific adsorption preventing film) for preventing nonspecific adsorption of protein to the surfaces of the channels 8 and 10, the reaction substance-holding portion 16, and the detecting portion 6. The antibody material may be immobilized by a known method.

Next, a test solution containing an antigen is injected through the introducing aperture 4 and led from the first channel 8 to the reaction substance-holding portion 16 to cause an antibody-antigen reaction between the antigen contained in the test solution and the antibody material immobilized on the solid fine particles 14, thus forming an immobilized antibody-antigen composite.

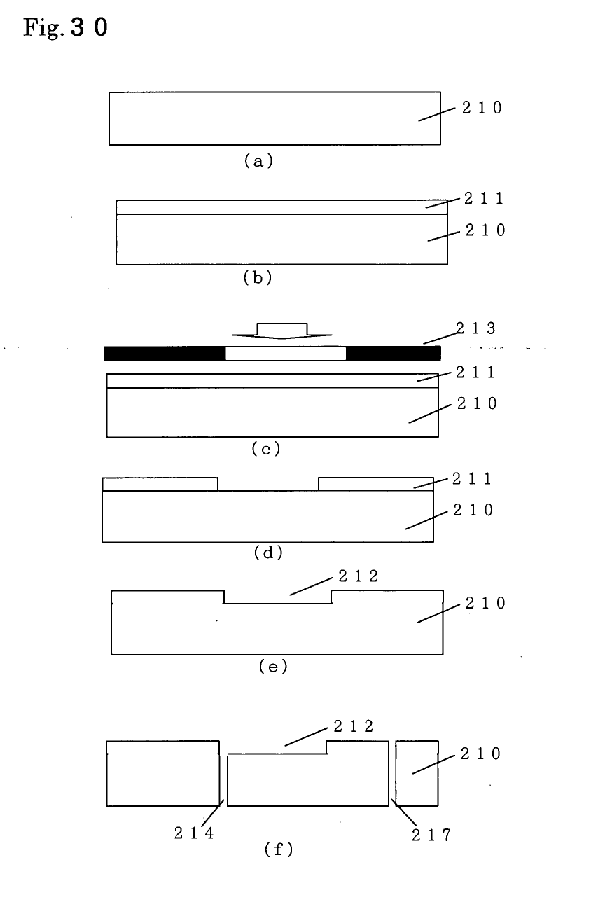

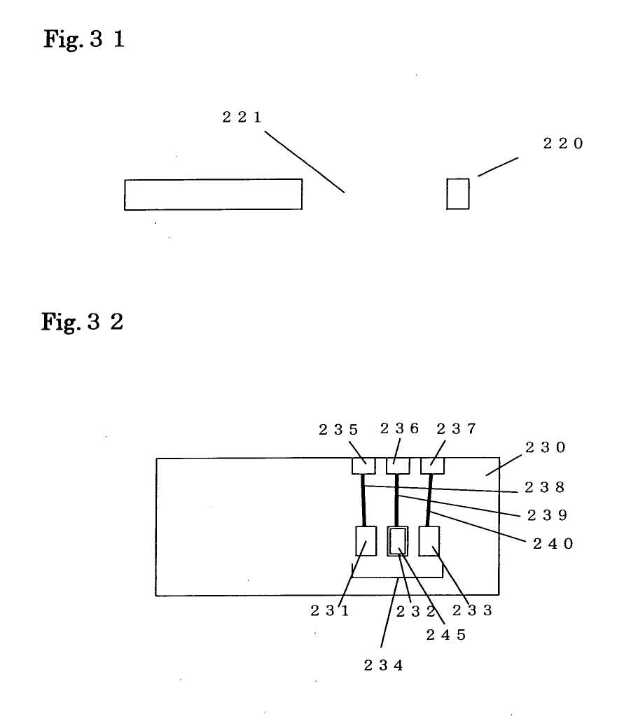

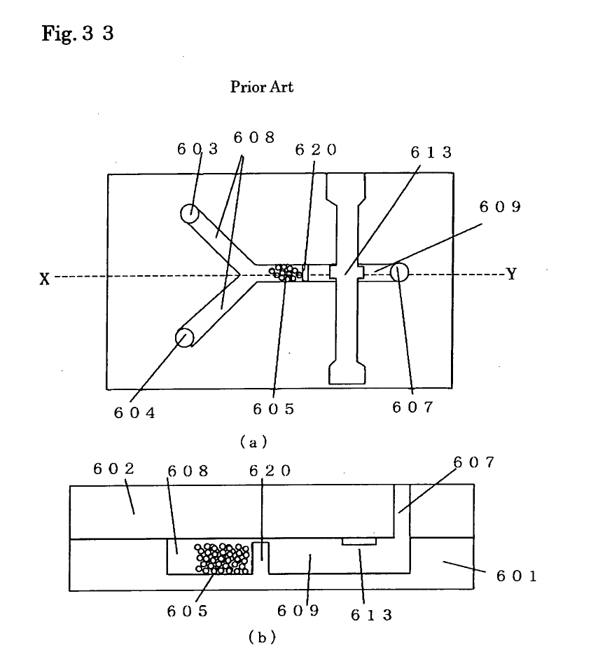

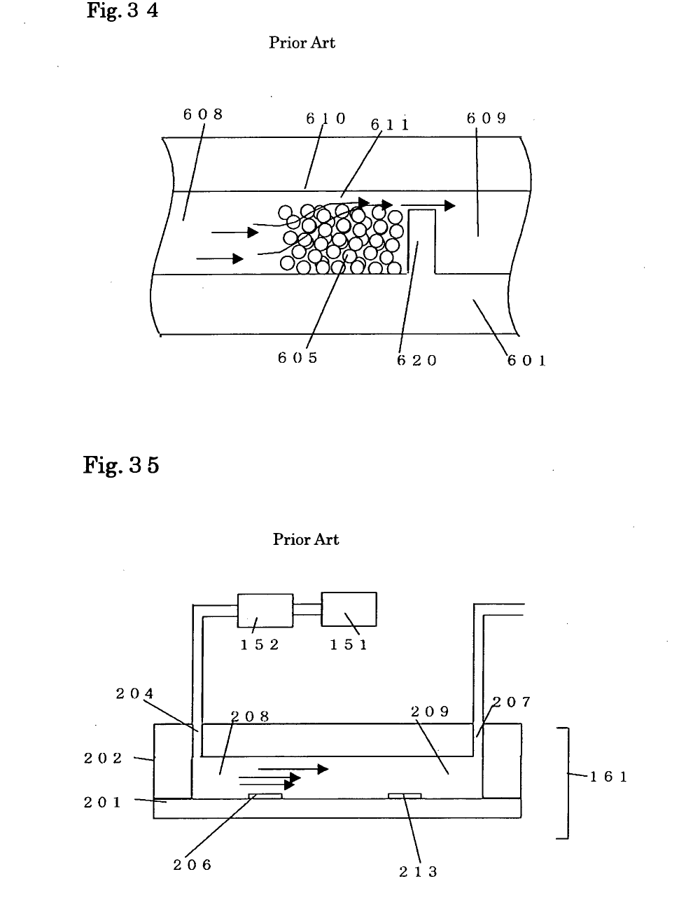

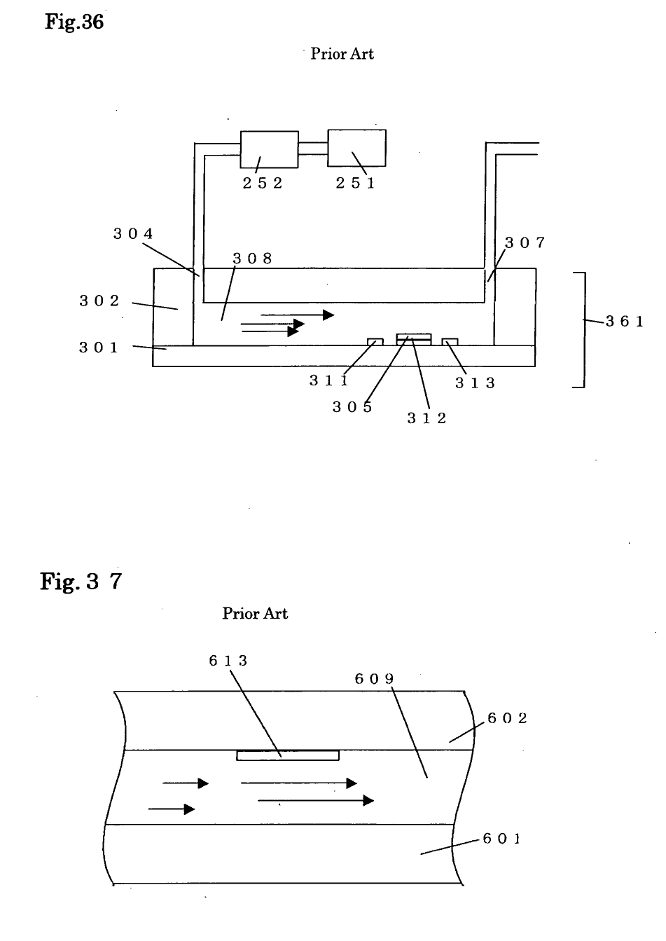

According to this embodiment, as shown in FIG. 3, the flow of fluid injected through the introducing aperture 4 is veered at the reaction substance-holding portion 16 from the horizontal direction to the vertical direction, as indicated by arrows 20. The change in flow direction causes the fluid to flow while hitting the entire fine particles 14. This increases the chance of meeting between the antibody material on the surfaces of the fine particles 14 and the antigen, as compared with the conventional microchannel shown in FIG. 34, thus improving the reaction efficiency. Also, the reaction time can be shortened.

Then, a buffer solution, instead of the test solution, is injected through the introducing aperture 4 to wash the channels 8 and 10, a reaction portion 5, and the detecting portion 6.

Then, through the introducing aperture 4 is injected a buffer solution containing an antibody material attached with an enzyme serving as a sign to cause an antibody-antigen reaction between the buffer solution and the antigen captured by the antibody immobilized on the reaction portion. Thus, a composite of immobilized antibody, antigen, and enzyme sign-attached antibody material is formed on the surfaces of the fine particles.

In order to remove unreacting part of the enzyme sign-attached antibody, a buffer solution is injected through the introducing aperture 4 thereby washing the channels 8,9 and 10, the reaction substance-holding portion 16, and the detecting portion 6.

Because of the same reason as the one provided in the above description of the antibody-antigen reaction, the reaction between the antigen and the antibody attached with the enzyme sign proceeds at a higher rate than that in the conventional structure. This reduces the amount of the antibody attached with the enzyme sign to flow and shortens the reaction time at the same time.

Next, through the introducing aperture 4 is injected a buffer solution containing a substrate material that changes its absorbance by the enzyme serving as the sign in order to allow the substrate material to react to the enzyme of the composite of immobilized antibody, antigen, and enzyme sign-attached antibody material. Thus, an absorbing substance that corresponds to the amount of the composite is formed. The enzyme material serving as the sign and the substrate material are well known in the art.

Because of the same reason as the one provided in the above description of the antibody-antigen reaction, the enzyme reaction proceeds at a higher rate than that in the conventional structure. The improved reaction efficiency leads to the advantage of reducing the amount of the substrate material to flow. Also, the reaction time can be shortened.

Then, the thermal lens 25 detects the amount of the substance that changes its absorbance, thereby enabling it to know the amount of the specimen.

When the reaction substance immobilized on the solid fine particles is degraded, a solution is injected through the discharging aperture 7 to wash out the solid fine particles along with the solution through the introducing aperture 4, followed by refilling the device with solid fine particles. Thus, the microchannel device can be repeatedly used. Alternatively, a solid fine particle-dedicated aperture through which to remove the solid fine particles may be additionally provided.

### Embodiment 1-2

In this embodiment, as shown in FIG. 4(a), the reaction substance, which identifies the specimen, is formed into a reaction substance-holding portion by being directly immobilized physically or by chemical reaction to each of inter-inlet regions 11 of a plurality of third channels that is located on a floor surface of the first channel. The reaction substance to be immobilized may be similar to that in embodiment 1-1. Also the channel structure and substrate material may be similar to those in embodiment 1-1.

According to this embodiment, as shown in FIG. 4(b), the flow of fluid injected through the introducing aperture 4 is veered at the reaction substance-holding portion 16 from the horizontal direction to the vertical direction, as indicated by arrows 20. This causes the reaction substance and the antigen to react to one another uniformly throughout the reaction substance-holding portion 16. Also, the reaction time can be shortened.

Immobilizing the reaction substance directly onto the substrate poses the problem of difficulty in replacing the reaction substance, which has limited the device to only a few times of practice or to disposable use. In this embodiment, as shown in FIG. 4, since the reaction substance is immobilized on the third substrate 3, only the second substrate 2 needs to be replaced to renew the identifying material by making the mutually adhered first and third substrates 1 and 3 easily peelable. Thus, the device can be repeatedly used.

As shown in FIG. 4(c), the reaction substance-holding portion 16 may be extensive beyond the inter-inlet regions 11 of the plurality of third channels, on the floor surface of the first channel. FIG. 4(c) is a plan view of the device.

### Embodiment 1-3

This embodiment has a similar structure to that of embodiment 1-2 except that the third substrate 3 has a single larger aperture over which a filter is placed, and that the reaction substance-holding portion 16 having formed thereon the reaction substance for identifying the specimen is formed on the first channel-side surface of the filter. This structure provides similar advantageous effects as those provided in embodiment 1-2.

### Embodiment 1-4

This embodiment has a similar structure to that of embodiment 1-2 except that in place of the third substrate 3, a filter 5 is provided between the first substrate and the second substrate, and that the reaction substance-holding portion 16 having formed thereon the reaction substance for identifying the specimen is formed on the first channel-side surface of the filter 5. This structure provides similar advantageous effects as those provided in embodiment 1-2

### Second Embodiment Group

The second embodiment group is drawn to an analytical microchannel device that electrochemically detects the amount of the specimen.

### Embodiment 2-1

FIG. 6(a) is a cross sectional view of a microdevice according to this embodiment. The microdevice according to this embodiment includes a channel A, a channel B that is parallel to the channel A, and a channel C that vertically connects the channels A and B to one another. An electrochemical detection-dedicated electrode 13 is disposed on a floor surface of a portion of the channel B that is immediately under (in the flow direction) the channel C and meets the channel C at a substantially right angle. It should be noted that the channels A, B, and C respectively correspond to the first, second, and third channels of the first embodiment group.

As shown in FIG. 6, this microdevice is composed of a lamination of four substrates a, b1, b2, and c.

Referring to FIG. 6, the substrate a has the channel A. The thickness of the substrate a is preferably approximately 0.1 mm to 0.5 mm.

The substrate b1 has the channel B, which is parallel to the channel A. The substrate b1 also has therethrough a hole that provides communication between the introducing aperture 4 and the channel A. The thickness of the substrate b 1 is preferably approximately 0.005 mm to 5 mm.

The substrate b2 has the introducing aperture 4 and the discharging aperture 7. The electrochemical detection-dedicated electrode 13 is disposed on a floor surface of a portion of the channel B that is immediately under the channel C and meets the channel C at a substantially right angle. The electrochemical detection-dedicated electrode 13 is usually composed of a working electrode, an opposing electrode, and a reference electrode. The reference electrode may be omitted. The electrode structure is not particularly specified.

The thickness of the substrate b2 is preferably approximately 0.1 mm to 5 mm. For the electrode to be formed and a wiring pattern to the electrode, known materials may be used.

The substrate c has the channel C, which meets the channel A at a right angle. The substrate c also has therethrough a hole that provides communication between the introducing aperture 4 and the channel A. The thickness of the substrate c is preferably approximately 0.005 mm to 5 mm.

The structures of the channels A and C may be similar to those of the first and third channels, respectively, of the first embodiment group. Also the substrate materials may be same as those in the first embodiment group. The channel C may be in any shape insofar as, preferably, no turbulence occurs in the channel. The separate formation of the substrate b1 and the substrate b2 is for technical purposes; the channels form steps on the substrates and thus wiring for the electrode 13 is difficult on the steps. Where there are no such problems, the substrate b1 and the substrate b2 may be formed into an integral substrate.

The channels A, B, and C, and the electrochemical detection-dedicated electrode 13 of the microdevice are filled with a buffer solution (e.g., phosphoric acid buffer solution) in advance. Then, a buffer solution is injected through the introducing aperture 4 to wash the interior of the device with the buffer solution.

Next, a test solution containing an electrically active substance is injected through the introducing aperture 4.

In this embodiment, as shown in FIG. 6(b), the solution flows while hitting the surface of the electrode 13 at a right angle. This increases the possibility of the electrically active substance of the solution coming into contact with the electrode surface and thus efficiently causes oxidation-reduction reactions, resulting in an increased current value and heightened sensitivity.

### Embodiment 2-2

FIG. 7 is a cross sectional view of a microdevice according to embodiment 2-2. This embodiment is similar to embodiment 2-1 except that the channel C is composed of a plurality of fine channels. This structure makes more frequent the contact between the electrically active substance of the solution and the electrode.

For the fine channels, the plurality of apertures used in embodiment 1-1 or a filter may be used.

### Embodiment 2-3

FIG. 8 is a cross sectional view of a microdevice according to embodiment 2-3. This embodiment is similar to embodiment 2-2 except that the electrochemical detection-dedicated electrode 13 is disposed in each of inter-inlet regions of the plurality of channels C that is located on a floor surface of the channel A. In this embodiment, the electrode is not disposed on the floor surface of the channel B, which eliminates the need for providing separate two substrates as in embodiment 2-1.

In this embodiment, as shown in FIG. 8(b), the solution flows while hitting the surface of the electrode 13 at a right angle. This increases the possibility of the electrically active substance of the solution coming into contact with the electrode surface and thus efficiently causes oxidation-reduction reactions, resulting in an increased current value and heightened sensitivity.

### Embodiment 2-4

FIG. 9 is a cross sectional view of a microdevice according to embodiment 2-4. This embodiment is similar to embodiment 2-1 except that a wall X for vertically veering the flow through the channel A is provided at the lower stream-side end of the channel A is provided in place of the channel C.

In this embodiment, as shown in FIG. 9(b), the solution flows while hitting the surface of the electrode 13 at a right angle. This increases the possibility of the electrically active substance of the solution coming into contact with the electrode surface and thus efficiently causes oxidation-reduction reactions, resulting in an increased current value and heightened sensitivity.

### Third Embodiment Group

The third embodiment group is drawn to a microdevice that is a combination of the first embodiment group and the second embodiment group.

### Embodiment 3-1

FIG. 10 is a cross sectional view of a microchannel device (microdevice) according to embodiment 3-1. The microdevice includes a first channel 8 (corresponding to the channel A), a second channel 10 (corresponding to the channel B) that is parallel to the first channel 8, and a third channel 15 (corresponding to the channel C) that vertically connects the first and second channels to one another. On an upper stream-side end portion of the first channel 8 is formed an introducing aperture 4 through which a test solution, buffer solution (e.g., phosphoric acid buffer solution), and the like are injected into the microdevice. On a lower stream-side end portion of the second channel 10 is formed a discharging aperture 7 through which the test solution, buffer solution, and the like are discharged out of the microdevice. In the vicinity of an inlet of the third channel 15, the first channel 8 has therein a reaction substance-holding portion 16 that holds and prevents drainage of fine particles 14 each having immobilized thereon a reaction substance that reacts exclusively to a specimen contained in the test solution. In addition, an electrochemical detection-dedicated electrode 13 (corresponding to the detecting portion) is disposed on a floor surface of a portion of the second channel that is immediately under the third channel and meets the third channel at a substantially right angle.

In this embodiment, the first substrate 1 corresponds to the substrate a of the second embodiment group, the second substrate 2 to the substrate b of the second embodiment group, and the third substrate to the substrate c of the second embodiment group. The channel structure and substrate material may be similar to those in embodiment 1-1.

An electrode is provided on the second substrate 2; however, when there is a problem of step, the second substrate 2 may be adapted to be composed of two substrates, one having formed thereon the second channel and the other having formed thereon the electrode. The first substrate and the third substrate may be formed into an integral substrate.

Description will now be made of detection of, for example, an antigen such as allergen with the use of the microdevice.

The channels 8, 10, and 15 the reaction substance-holding portion 16, and the electrochemical detection-dedicated electrode 13 of the microdevice are filled with a buffer solution (e.g., phosphoric acid buffer solution) in advance. Next, through the introducing aperture 4 is injected a buffer solution with which to wash the interior of the microdevice. Then, through the introducing aperture 4 are injected a plurality of fine particles 14 each having immobilized thereon an antibody material along with a buffer solution. Preferably, an albumin aqueous solution is then allowed to flow to form an albumin film (nonspecific adsorption preventing film) for preventing nonspecific adsorption of protein to the surfaces of the channels 8 and 10, the reaction substance-holding portion 16, and the detecting portion 6.

Next, a test solution containing an antigen is injected through the introducing aperture 4 and led to the reaction substance-holding portion 16 to cause an antibody-antigen reaction between the antigen contained in the test solution and the antibody material immobilized on the solid fine particles 14, thus capturing the antigen.

Next, a buffer solution, instead of the test solution, is injected through the introducing aperture 4 to wash the channels 8, 10, and 15, the reaction substance-holding portion 16, and the electrode 13.

Next, through the introducing aperture 4 is injected a buffer solution containing an antibody material attached with an enzyme serving as a sign to cause an antibody-antigen reaction between the buffer solution and the antigen captured by the antibody immobilized on the reaction portion. Thus, a composite of immobilized antibody, antigen, and enzyme sign-attached antibody material is formed on the surfaces of the fine particles.

In order to remove unreacting part of the enzyme sign-attached antibody, a buffer solution is injected through the introducing aperture 4 thereby washing the channels 8, 10, and 15, the reaction substance-holding portion 16, and the electrode 13.

Because of the same reason as the one provided in the above description of the antibody-antigen reaction, the reaction between the antigen and the antibody attached with the enzyme sign proceeds at a higher rate than that in the conventional structure. This reduces the amount of the antibody attached with the enzyme sign to flow and shortens the reaction time at the same time.

Next, through the introducing aperture 4 is injected a buffer solution containing a substrate material that generates an electrically active substance by the enzyme serving as the sign in order to allow the substrate material to react to the enzyme of the composite of immobilized antibody, antigen, and enzyme sign-attached antibody material. Thus, an electrically active substance that corresponds to the amount of the composite is formed. The enzyme material serving as the sign and the substrate material are well known in the art.

Then, the electrochemical detection-dedicated electrode 13 detects the amount of the electrically active substance, thereby enabling it to know the amount of the specimen.

### Embodiment 3-2

FIG. 11 is a cross sectional view of a microdevice according to embodiment 3-2. The microdevice according to this embodiment is similar to embodiment 3-1 except that the reaction substance is formed into the reaction substance-holding portion 16 by being directly immobilized physically or by chemical reaction to each of inter-inlet regions of a plurality of third channels that is located on a floor surface of the first channel instead of immobilizing the reaction substance onto the solid fine particles.

### Embodiment 3-3

FIG. 12 is a cross sectional view of a microchannel device (microdevice) according to embodiment 3-3. The microdevice includes a first channel 8 (corresponding to the channel A), a second channel 10 (corresponding to the channel B) that is parallel to the first channel 8, a third channel 15 (corresponding to the channel C) that vertically connects the first and second channels to one another, a fourth channel 9 that is parallel to the second channel 10, and a fifth channel 17 that vertically connects the second and fourth channels to one another. On an upper stream-side end portion of the first channel 8 is formed an introducing aperture 4 through which a test solution, buffer solution (e.g., phosphoric acid buffer solution), and the like are injected into the microdevice. On a lower stream-side end portion of the fourth channel 9 is formed a discharging aperture 7 through which the test solution, buffer solution, and the like are discharged out of the microdevice. In the vicinity of an inlet of the third channel 15, the first channel 8 has therein a reaction substance-holding portion 16 that holds and prevents drainage of fine particles 14 each having immobilized thereon a reaction substance that reacts exclusively to a specimen contained in the test solution. In addition, an electrochemical detection-dedicated electrode 13 (corresponding to the detecting portion) is disposed on each of inter-inlet region paths of the fifth channel 17 that meet the second channel 10 at a substantially right angle.

Referring to FIG. 12, the first substrate 1 has the introducing aperture 4, the first channel 8, the fourth channel 9, and the discharging aperture 7. The reaction substance-holding portion 16 is formed in the first channel 8 in the vicinity of the inlet of the third channel 15, and holds the fine particles 14 so as to prevent drainage thereof. The thickness of the first substrate 1 is preferably 0.1 mm to 5 mm.

The second substrate 2 has the second channel 10, which is parallel to the first channel 8, which is formed in the first substrate 1. An upper-stream end of the second channel 10 is opposed to a lower-stream end of the first channel 8, and a lower-stream end of the second channel 10 overlaps with an upper-stream end of the fourth channel 9 in the manner shown in FIG. 12. The thickness of the second substrate 2 is preferably approximately 0.1 mm to 5 mm.

The third substrate 3 has the third channel 15, which vertically connects the first channel 8 and the second channel 10 to one another, and a plurality of fifth channels that vertically connect the second channel 10 and the fourth channel 9. The electrochemical detection-dedicated electrode 13 (corresponding to the detecting portion) is disposed on each of the regions between the inlets of the plurality of fifth channels that are located on the floor surface of the second channel 10.

### Embodiment 3-4

FIG. 13 is a cross sectional view of a microdevice according to this embodiment. This embodiment has a similar structure to that of embodiment 3-3 except that instead of disposing the fine particles 14 having immobilizing thereon the reaction substance in the first channel 8, the reaction substance is immobilized on the inlets of the third channels 15 that are on a floor surface of the first channel 8, thus forming the reaction substance-holding portion 16.

### Embodiment 3-5

FIG. 14 is a cross sectional view of a microdevice according to this embodiment. This embodiment has a similar structure to that of embodiment 3-3 except that a single fifth channel 17 is provided, that the electrochemical detection-dedicated electrode 13 is not provided on the inlet of the fifth channel 17, and that the electrochemical detection-dedicated electrode 13 is disposed on the floor surface of a portion of the fourth channel 9 that is immediately above the fifth channel 17 in the flow direction.

### Embodiment 3-6

FIG. 15 is a cross sectional view of a microdevice according to this embodiment. This embodiment has a similar structure to that of embodiment 3-3 except that instead of disposing the electrochemical detection-dedicated electrode 13 in the inlets of the plurality of fifth channels 17, which are fine channels, the electrochemical detection-dedicated electrode 13 is disposed on the floor surface of a portion of the fourth channel 9 that is immediately above the fifth channels 17 in the flow direction.

(Common Notes for the Embodiments)

While in the above embodiments the wall surface of the first channel 8 and that of the second channel 10 and the wall surface of the second channel 10 and that of the fourth channel 9 are parallel, the channels may be slanted or curved on respective end portions as shown in FIGS. 16 and 17. These structures provide a smoother flow for the solution. However, when an electrode is provided on the floor surface of the second channel 10 or the fourth channel 9, a slanted structure is preferably not provided for the channel.

### Fourth Embodiment Group

The fourth embodiment group is drawn to an analytical microchannel device such that the electrochemical detection-dedicated electrode according to the second embodiment group that bends the flow of the test solution to cause it to hit the electrode at a substantially right angle has on a surface of the electrode a substance that reacts exclusively to the specimen contained in the test solution.

### Embodiment 4-1

FIGS. 20(a) and 20(b) are cross sectional views of an analytical microchannel device according to embodiment 4-1. The analytical microchannel device according to this embodiment includes a channel A (corresponding to the first channel 8), a channel B (corresponding to the second channel 10) that is parallel to the channel A, and a channel C (corresponding to the third channel 15) that vertically connects the channels A and B to one another. An electrochemical detection-dedicated electrode 13 is disposed on a floor surface of a portion of the channel B that is immediately under the channel C in the flow direction and meets the channel C at a substantially right angle. Similarly to the above, the electrochemical detection-dedicated electrode 13 is composed of a working electrode, a reference electrode, and an opposing electrode. On the surface of the working electrode is provided a reaction substance 51 for identifying the specimen.

The reaction substance 51 reacts exclusively to the specimen, which is the detection target substance, contained in the test solution in order to capture the specimen. However, the reaction substance 51 is ever changing its state during use for analysis because the specimen captured by the reaction substance 51 is made to react to one substance after another. Examples of the reaction substance 51 include antibody materials such as a monoclonal antigen and polyclonal antigen, and what are called artificial antigen materials such as an imprinting polymer, aptamer material, and peptide material. The reaction substance may be immobilized on the surface of the working electrode in order to prevent the reaction substance from being drained by a solution flowing inside the device. The method for immobilization is not particularly specified. For example, the reaction substance may be physically adsorbed onto the electrode surface by the adsorption force of the reaction substance itself, or may immobilized by a covalent bond through a self-assembled film.

As material for the working electrode and the opposing electrode include gold, platinum, and titanium are exemplified. As material for the reference electrode, silver/silver chloride (front layer side), or gold, platinum, and titanium on which silver/silver chloride (front layer side) is formed is exemplified.

Embodiment 4-1 is similar to embodiment 2-1 (FIG. 6) except that the reaction substance is formed on the electrochemical detection-dedicated electrode 13. In FIGS. 6 and 25, the electrochemical detection-dedicated electrode 13 is composed of a working electrode, an opposing electrode, and a reference electrode (not shown). Embodiment 4-1 differs from embodiment 2-1 in that the reaction substance is formed on the surface of the working electrode, which is a constituent of the electrochemical detection-dedicated electrode 13 while the electrochemical detection-dedicated electrode 13 shown in FIG. 20 (also in FIGS. 6-9 and 21-23) is composed of a working electrode, an opposing electrode, and a reference electrode, the figure results from cutting the working electrode in the longitudinal direction from the vertical direction, and therefore the opposing electrode and the reference electrode are not shown. The opposing electrode is located on the front side of the drawing and the reference electrode is located on the far inner side of the drawing.

Next, the basic operation of the microchannel device of this embodiment will be described taking as an example the case where the specimen contained in the test solution is the antigen and the reaction substance disposed on the working electrode of the electrochemical detection-dedicated electrode 13 is the antibody that reacts exclusively to the antigen.

The channels A, B, and C, and the electrochemical detection-dedicated electrode 13 of the microchannel device are filled with a buffer solution (e.g., phosphoric acid buffer solution) to fill the electrochemical detection-dedicated electrode 13 and the reaction substance 51 (antibody layer). Then, a buffer solution is further introduced through the introducing aperture 4 to wash the interior of the microchannel device with the buffer solution. Preferably, an albumin aqueous solution is then allowed to flow to form an albumin film (nonspecific adsorption preventing film). This prevents nonspecific adsorption of protein to the surfaces.

Next, a test solution containing the antigen is injected through the introducing aperture 4 and allowed to flow through the device. This causes an antibody-antigen reaction between the antigen contained in the test solution and the antibody immobilized on the working electrode of the electrochemical detection-dedicated electrode 13, thus capturing the antigen in the test solution on the working electrode.

Referring to FIG. 20(b), in the microchannel device of embodiment 4-1, the test solution injected through the introducing aperture 4 flows through the channel A, and is made to veer its flow direction at the channel C in order to cause the veered flow to hit the electrochemical detection-dedicated electrode 13 at a substantially right angle. Then the flow veers to the horizontal direction, as indicated by arrows 20. This structure causes the specimen (antigen molecules) existent in the test solution to hit the antibody layer (reaction substance 51) on the front, which is disposed on the electrochemical detection-dedicated electrode 13. This secures that the antigen molecules in the test solution to react to the antibody molecules, thus enabling a reduction in reaction time and an improvement in reaction efficiency.

Next, a similar buffer solution to the above is introduced through the introducing aperture 4 instead of the test solution in order to wash the channels A, B, and C, and the electrochemical detection-dedicated electrode 13. Next, an antibody material attached with an enzyme serving as a sign is introduced through the introducing aperture 4 to cause an antibody-antigen reaction between the antibody material and the antigen captured by the antibody layer (reaction substance 51). Thus, a composite of antibody, antigen, and enzyme sign-attached antibody material is formed.

A buffer solution is again introduced through the introducing aperture 4 to wash away unreacting part of the enzyme sign-attached antibody from the channels A, B, and C, and the electrochemical detection-dedicated electrode 13. Also in this reaction (between the antigen and the enzyme sign-attached antibody), the buffer solution containing the enzyme sign-attached antibody hits the reaction portion on the front, resulting in a highly efficient reaction, as described above with reference to the antibody-antigen reaction. This reduces the amount of the enzyme sign-attached antibody and shortens the reaction time.

Then, a buffer solution containing a substrate material that generates an electrically active substance by reacting to the enzyme of the enzyme sign-attached antibody is injected through the introducing aperture 4. This causes the substrate material and the enzyme of the composite of antibody, antigen, and enzyme sign-attached antibody material formed on the working electrode of the electrochemical detection-dedicated electrode 13 to react to each other, thus generating an electrically active substance that corresponds to the amount of the composite. The amount of the electrically active substance generated is measured as the amount of current at the electrochemical detection-dedicated electrode 13 to calculate the amount of the specimen contained in the test solution.

It should be noted that the analytical microchannel device according to this embodiment (and the other embodiments) is characterized in the channel structure, location of the electrode, and the like; there is no particular limitation to the kind of the specimen, the reaction substance, the enzyme material serving as a sign, and the substrate material. Thus, the reaction substance may be conveniently selected in accordance with the kind of the specimen.

### Embodiment 4-2

FIGS. 21(a) and 21(b) show cross sectional views a microchannel device according to embodiment 4-2. This embodiment is similar to embodiment 4-1 except that the channel C is composed of a plurality of fine channels. This structure, in which the channel C is composed of a plurality of fine channels, enables it to substantially vertically veer the flow inside the device further more reliably. This further enhances the chance of hitting the electrochemical detection-dedicated electrode 13 by the antigen in the test solution, enzyme sign-attached antibody, and the substrate material, resulting in reactions with enhanced efficiency.

For the channel C composed of a plurality of fine channels, a filter or a mesh with pores of approximately 1 μm to 200 μm in diameter may be disposed between the channel A and the channel B.

### Embodiment 4-3

FIGS. 22(a) and 22(b) show cross sectional views a microchannel device according to embodiment 4-3. This embodiment is similar to embodiment 4-2 except that the electrochemical detection-dedicated electrode 13 and the reaction substance 51, which reacts exclusively to the specimen, are not disposed on the floor surface of the channel B, but in each of inter-inlet regions (portions between the inlets) of the plurality of fine channels of the channel C that is located on a floor surface of the channel A.

Referring to FIG. 22(b), in the microchannel device of this embodiment, the electrochemical detection-dedicated electrode 13 and the reaction substance 51 are disposed in each of inter-inlet regions of the plurality of fine channels of the channel C. In other words, the electrochemical detection-dedicated electrode 13 and the reaction substance 51 are disposed at a position where the flow of the solution through the channel A is intended to be veered. This provides a higher chance of contact between the specimen molecules and the reaction substance 51 and the like than the one provided by the conventional structure, in which the electrode is disposed in parallel to the flow direction. Thus, the advantageous effect of highly efficient reaction, as described above, is realized.

Also, embodiment 4-3 eliminates the need for the electrode to be formed on the floor surface of the channel B; it is only necessary to form the channel B, the introducing aperture 4, and the discharging aperture 7 on the substrate. Thus, there is no need for two substrates, b1 and b2, as in embodiment 4-1. This provides the advantageous effect of facilitated fabrication.

### Embodiment 4-4

FIGS. 23(a) and 23(b) show cross sectional views a microchannel device according to embodiment 4-4. This embodiment is similar to embodiment 4-1 except that instead of providing the channel C, a wall X for vertically veering the flow through the channel A is disposed at a lower-stream end of the channel A.

Referring to FIG. 23(b), in the microchannel device of this embodiment, the flow of the solution is veered by the wall X disposed on the channel A so that the solution hits the electrochemical detection-dedicated electrode 13 at a substantially right angle. This makes much higher the chance of contact between the specimen molecules and the reaction substance 51 and the like than the one provided by the conventional structure, in which the electrode is disposed in parallel to the flow direction. Thus, the above-described advantageous effect is realized.

In this embodiment, the higher height and closer position of the wall X to the electrochemical detection-dedicated electrode 13 enables the solution to surely hit the electrochemical detection-dedicated electrode 13 and the reaction substance 51.

In this structure, the solution of which the flow is blocked by the wall X becomes turbulent. Therefore, the effect that specimen molecules collides with electrode from various angles can be realized.

The present invention will be described in further detail with reference to examples.

### EXAMPLE 1

Example 1 corresponds to embodiment 3-3. An analytical microchannel device according to example 1 was prepared in the following manner.

Referring to FIG. 24, a thick resist 111 was placed on a mold substrate 115 (a and b), which were then formed into a mold 113 using a photomask 112 with a desired pattern (c and d). A thermosetting resin PDMS (polydimethylsiloxane) 110 was poured into the mold 113, thus forming on its surface a first channel 118 and a fourth channel 119 (e and f). Subsequently, an introducing aperture 114 and a discharging aperture 117 were formed (g), thus forming a first substrate 110 shown in FIG. 24(h) (in a plan view).

Referring to FIG. 25, a p-type resist 121 was formed on a glass substrate 120 (a and b). A rectangular hole of 0.3 mm wide and 2 mm long was formed on the resist 121 by photolithography (c and d), which was followed by formation of a rectangular channel 122 of 0.05 mm deep on the surface of the glass substrate by wet etching (e), thus obtaining a second substrate 120 (plan view f).

An acrylic substrate of 0.5 mm thick was prepared. A plurality of third channels 132 and a plurality of fifth channels 133 each of 0.1 mm in diameter were formed in the pattern shown in FIG. 26 on an acrylic substrate 130 of 0.5 mm thick were formed on portions of the acrylic substrate corresponding to overlapping regions of the channels 118 and 119 of the first substrate 110 and the channel 122 of the second substrate 120. The acrylic substrate was made a third substrate 130.

The size of the substrate was 25 mm by 25 mm. The channels 118, 119, and 122 each was 0.3 mm wide and 0.05 mm deep. The first substrate 110 and the second substrate 120 were designed such that when they were superposed on top of one another, the channel 122 would overlap with the channels 118 and 119 and connect them to one another.

On the third substrate 130 were formed a working electrode 135, a reference electrode 134, an opposing electrode 136 each of 0.2 mm on each side, connection pads 137, 138, and 139 each of 3 mm on each side and respectively corresponding to the electrodes 134, 135, and 136, and wires 140, 141, and 142 each connecting the corresponding electrode and pad. The method of formation was a combination of conventional photolithography and lift-off, by which a part of each electrode and connection pad were exposed, while the remaining part was covered with an insulating film (not shown). The electrode material was platinum and titanium was used as a ground layer between the electrodes and the substrate.

The first substrate 110, the third substrate 130, and the second substrate 120 were superposed on top of each other. The resulting product was connected to a syringe pump 151 and a rheodyne bulb 152. Then, fine particles 170 having on each surface an anti-Cry J-1 antibody were injected through the introducing aperture 124 along with a phosphoric acid buffer solution, thus forming a reaction substance-holding portion. Thus, an analytical microchannel device 150 shown in FIG. 27 was completed.

Next, a method of detection using the analytical microchannel device according to this example will be described taking allergen as an example, with reference to FIG. 27.

In a 7.4 pH phosphoric acid buffer solution, Cry J-1, which was a cedar pollen allergen, was prepared at a concentration of 100 ng/ml. This preparation was injected at 5 μl from the rheodyne bulb 152 to the interior of the device while allowing a phosphoric acid buffer solution to flow through the device by activating the syringe pump 151. This caused, inside the microdevice, the Cry J-1 to react to the anti-Cry J-1 antibody immobilized on the surfaces of the fine particles 170.

Then, only a buffer solution was allowed to flow through the device to wash the interior of the device.

Next, an enzyme sign-attached anti-Cry J-1 antibody was allowed to flow inside the device to form a composite of antibody, antigen, and enzyme sign-attached antibody on the surfaces of the fine particles 170. As the enzyme, alkaline phosphatase was used.

Then, a buffer solution containing para-amino phenyl phosphate, which served as a substrate material, at a concentration of 0.1 mM was introduced from the rheodyne bulb 152 to the interior of the analytical microchannel device 150 through the introducing aperture 114. The para-amino phenyl phosphate injected into the chip was rendered para-amino phenol, which served as an electrically active substance, by the alkaline phosphatase enzyme of the composite of antibody, antigen, and enzyme sign-attached antibody, which was formed on the surfaces of the fine particles 170 (enzyme substrate reaction). The para-amino phenol was detected as an oxidation-reduction current at the electrode 154. Specifically, para-amino phenol was measured by an external potentiometer connected to the electrode 154 through the connection pads 137, 138, and 139.

### COMPARATIVE EXAMPLE 1

As comparative example 1, the conventional microdevice shown in FIG. 33 was subjected to the same detection as the one in this example under the same conditions including the amount of fine particles. The comparison showed that the current value in example 1 was approximately ten times that in the microdevice in comparative example 1.

This indicates that example 1 significantly improves the detection sensitivity. Thus, the microdevice of example 1 reliably detects the amount of the specimen even when the specimen is used in small amounts.

### EXAMPLE 2

FIG. 28 shows an analytical microchannel device 180 according to example 2. Example 2 corresponds to embodiment 3-4. In the analytical microchannel device 180 according to example 2, a reaction substance-holding portion 190 was composed of anti-Cry J-1 antibodies each physically immobilized on the inlets of the third channels 132 (in inter-inlet regions of the third channels) located on the floor surface of the first channel, instead of disposing the fine particles in the first channel 118. Immobilization of the anti-Cry J-1 antibody was carried out by a conventional method. Except for the above structure, the analytical microchannel device 180 according to example 2 shown in FIG. 24 was prepared in the same manner as in example 1. With the use of the analytical microchannel device 180 (FIG. 28), Cry J-1, which was a cedar pollen allergen, was measured in the same manner as in example 1.

### COMPARATIVE EXAMPLE 1

As comparative example 2, an analytical microchannel device shown in FIG. 35 was prepared. An anti-Cry J-1 antibody material 206 was formed on a part of a substrate 201 in a conventional manner, and an electrode 213 was provided on another part of the substrate 201. The shape and manner of formation of the electrode were the same as in example 1. Similarly to example 1, a PDMS substrate 202 having formed thereon a channel of 0.2 mm wide and 0.05 mm deep, an introducing aperture, and a discharging aperture was superposed on the substrate 201. Thus, an analytical microchannel device 161 according to comparative example 2 was prepared.

The analytical microchannel device 161 according to comparative example 2 was also subjected to the same detection as the one in example 1. The comparison showed that the current value in example 2 was approximately twenty times that of the microchannel device of comparative example 2.

### EXAMPLE 3

FIG. 29 shows a cross sectional view of example 3, showing the entire structure of the example. Example 3 is a modified example of the analytical microchannel device according to embodiment 4-4 (FIG. 23). Referring to FIG. 29, the main portion of an analytical microchannel device according to example 3 is composed of three substrates: a first substrate 210, a second substrate 220, and a third substrate 230, which are superposed on top of each other.

The first substrate 210 includes an introducing aperture 214 through which a test solution is injected, a first channel 212 (corresponding to the channel, A in embodiment 4-4), and a discharging aperture 217 through which the test solution is discharged. The second substrate 220 includes a second channel 221 (corresponding to the channel B in embodiment 4-4), and an electrochemical detection-dedicated electrode 234 disposed on a floor surface of the second channel 221. The electrochemical detection-dedicated electrode 234 is composed of a an opposing electrode 231, a working electrode 232, and a reference electrode 233. In this microchannel device, a wall surface 213 disposed on the first substrate functions to veer the flow through the first channel 212 approximately vertically. The portion between an upper-stream side wall and the wall surface 213 of the first channel 212 corresponds to the channel C in embodiment 4-4.

A method for fabricating the microchannel device will be described. First, by a similar method to the one in example 1, a glass substrate of approximately 1 mm thick was formed into the first substrate 210, as shown in FIG. 30(f), in accordance with the process shown in FIG. 30. FIGS. 30(a) to 30(f) are cross sectional views.

An acrylic substrate of approximately 0.3 mm thick was formed into the second substrate 220 with an aperture 221 (corresponding to the channel C in embodiment 4-4), as shown in FIG. 31.

A silicon substrate of approximately 0.6 mm thick was used as the third substrate 230, on which the opposing electrode 231, working electrode 232, and reference electrode 233 each of 0.2 mm on each side were formed by a known thin-film formation technique such as photolithography, sputtering, and vacuum deposition. Also connection pads 235, 256, and 237 for respectively connecting the opposing, electrode 231, working electrode 232, and reference electrode 233 to an external appliance were formed and electrically connected to the respective electrodes respectively through connection wirings 238, 239, and 240. Thus, the third substrate 230 shown in FIG. 32 was prepared.

For the opposing electrode 231, platinum was used. For the working electrode 232, a two-layer structure of platinum/gold (front layer side) was used. For the reference electrode 233, a three-layer structure of platinum/silver/silver chloride (front layer side) was used. After the electrodes were formed, a silicon oxide layer (insulating film) was laminated over the entire electrode area excluding the electrodes and the connection pads. Then, an anti-Cry J-1 antibody, which reacted exclusively to cedar pollen allergen Cry J-1, was immobilized on the surface of the working electrode 232. The electrochemical detection-dedicated electrode 234 is composed of the opposing electrode 231, working electrode 232, and reference electrode 233.

Immobilization of the anti-Cry J-1 antibody was carried out by the following manner. After the surface of the working electrode 232 (gold electrode) was washed with pure water, a solution containing a 1:9 mixture in mole ratio of SH—C₁₀H₂₀—COOH and SH—C₆H₁₂—OH at a concentration of 10 mM was allowed to flow on the surface of the working electrode 232. Then the electrode surface was washed again with pure water. Thus, a self-assembled film (SAM film) with a protruding carboxyl group was formed on the surface of the working electrode 232. Next, a 1:1 mixture in mass ratio of water-soluble carbodiimide (EDC) and N-hydroxy succinimide (NHS) was dissolved in a pH 5.8 phosphoric acid, buffer solution (PBS) to prepare a solution containing the mixture at a concentration of 10 mg/ml. Then the gold electrode was immersed in the solution for 2 hours at 37° C. to cause the water-soluble carbodiimide (EDC) and N-hydroxy succinimide (NHS) to react to the gold electrode. Then, the electrode surface was washed with a pH 5.8 phosphoric acid buffer solution.

Next, an anti-Cry J-1 antibody was dissolved in a pH 5.8 phosphoric acid buffer solution to prepare a solution containing the anti-Cry J-1 antibody at a concentration of 10 mg/ml. The gold electrode was immersed in the solution for 2 hours at 37° C. to immobilize the anti-Cry J-1 antibody on the SAM film surface, which was disposed on the electrode surface. Then, the electrode surface was washed with a pH 7.4 phosphoric acid buffer solution containing 0.05% of Tween 20. Thus, a microchannel device 261 with an anti-Cry J-1 antibody layer (reaction substance 245) formed on the working electrode 232 was completed.

Meanwhile, a solution feeder having a syringe pump 251 and a rheodyne bulb 252 connected to one another through resin tube, and a discharging tube made of resin were prepared. The tube of the solution feeder was coupled to the introducing aperture 214 of the microchannel device 261, and the discharging tube was coupled to the discharging aperture 217. Thus, a microchannel device apparatus provided with the solution feeder was prepared.

Operation of the microchannel device apparatus for detection of the cedar pollen allergen Cry J-1 will be described with reference to FIG. 29. The cedar pollen allergen Cry J-1 was introduced in a pH 7.4 phosphoric acid buffer solution to prepare in advance a test solution containing the Cry J-1 at a concentration of 100 ng/ml. The syringe pump 251 was activated to allow a pH 7.4 phosphoric acid buffer solution to flow inside the microchannel device 261, and in this state, 5 μl of the test solution was injected into the microchannel device from the rheodyne bulb 252. This test solution was led to the first channel 212 through the introducing aperture 214, and veered at the wall surface 213, which is located ahead of the first channel 212, to enter the second channel 221, which was provided with the electrochemical detection-dedicated electrode 234 on the floor surface, and be discharged out of the microchannel device 261 through the discharging aperture 217.

In this course of flow, the test solution hits the electrochemical detection-dedicated electrode 234 at a substantially right angle, thus enabling efficient capture of the Cry J-1 in the test solution by the anti-Cry J-1 antibody (reaction substance 245) immobilized on the working electrode 232. Then, only a buffer solution was allowed to flow through the device to wash the interior thereof.

Next, from the rheodyne bulb 252, an enzyme sign-attached anti-Cry J-1 antibody was injected into the microchannel device 261 to form on the surface of the working electrode 232 a composite of antibody, antigen, and enzyme sign-attached antibody. As the enzyme, alkaline phosphatase was used.

Then, a buffer solution containing para-amino phenyl phosphate, which served as a substrate material, at a concentration of 0.1 mM was introduced from the rheodyne bulb 252 to the interior of the microchannel device 261. The para-amino, phenyl phosphate injected into the microchannel device 261 was rendered para-amino phenol, which served as an electrically active substance, by the alkaline phosphatase enzyme of the composite of antibody, antigen, and enzyme sign-attached antibody, which was formed on the surface of the working electrode 232 (enzyme substrate reaction). The para-amino phenol was detected as an oxidation-reduction current at the working electrode 232, which was located immediately under thereof. Specifically, the para-amino phenol was measured by a potentiometer connected to the connection pads 235, 236 and 237, which were respectively connected to the electrodes 231, 232 and 233.

### COMPARATIVE EXAMPLE 3

As comparative example 3, a microchannel device shown n FIG. 36 was prepared. The microchannel device according to comparative example 3 differs from example 3 in that an opposing electrode 311, a working electrode 312, and a reference electrode 313 are sequentially formed on a floor surface of a channel 308 so that each electrode surface is parallel to the flow direction. The same conditions as those in example 3 were used, including immobilization of the anti-Cry J-1 antibody on the working electrode 312.

Microchannel devices of example 3 and comparative example 3 were subjected to current measurement under the conditions specified in example 3. A comparison showed that the current value in example 3 was approximately ten times that of the microchannel device of comparative example 1. This indicates that example 3 significantly improves the detection sensitivity.

As has been described hereinbefore, the present invention provides an analytical microchannel device that is high in reactivity and sensitivity. The user of the analytical microchannel device enables detection of a specific protein. Also the analytical microchannel device can be applied to detection of various substances other than protein. Therefore, the industrial applicability of the analytical microchannel device is considerable.

What is claimed is:

1. An analytical microchannel device comprising:
a first channel through which a test solution flows;
a second channel substantially parallel to the first channel; and
a third channel substantially vertically connecting the first channel and the second channel to one another,
wherein in the vicinity of an inlet of the third channel, the first channel holds therein fine particles to prevent drainage thereof toward a lower stream side, each of the fine particles having a reaction substance reacting exclusively to a specimen contained in the test solution.

2. The analytical microchannel device according to claim 1, wherein the third channel comprises a plurality of fine channels each having a diameter smaller than a diameter of each of the fine particles, the plurality of fine channels preventing drainage of the fine particles.

3. The analytical microchannel device according to claim 1, wherein a wall surface of the first channel immediately above the third channel is slanted toward the third channel.

4. The analytical microchannel device according to claim 1, wherein a wall surface of the second channel immediately under the third channel is slanted toward the third channel.

5. The analytical microchannel device according to claim 1, further comprising a first substrate having a groove constituting the first channel, a second substrate having a groove constituting the second channel, and a third substrate having a through aperture for the third channel, the first substrate, the third substrate, and the second substrate being stacked atop each other in this order.

6. The analytical microchannel device according to claim 5, wherein:
the first substrate comprises an introducing aperture through which the test solution is injected and a discharging aperture through which the test solution is discharged; and
the third substrate comprises a hole providing communication between the groove constituting the second channel and the discharging aperture.

7. The analytical microchannel device according to claim 1, further comprising a first substrate 1a having a groove constituting the first channel and having formed thereon a through aperture for the third channel, a first substrate 1b serving as a lid for the groove of the first channel 1a, and a second substrate having a groove constituting the second channel, the first substrate 1b, the first substrate 1a, and the second substrate being stacked atop each other in this order.

8. The analytical microchannel device according to claim 7, wherein the first substrate 1b comprises an introducing aperture through which the test solution is injected and a discharging aperture through which the test solution is discharged.

9. The analytical microchannel device according to claim 1, further comprising an electrochemical detection-dedicated electrode disposed on a floor surface of a portion of the second channel, the portion being immediately under the third channel and meeting the third channel at a substantially right angle.

10. The analytical microchannel device according to claim 9, further comprising a first substrate having a groove constituting the first channel, a second substrate having a groove constituting the second channel and having formed thereon the electrochemical detection-dedicated electrode, and a third substrate having a through aperture for the third channel, the first substrate, the third substrate, and the second substrate being stacked atop each other in this order.

11. The analytical microchannel device according to claim according to claim 10, wherein:
the first substrate comprises an introducing aperture through which the test solution is injected and a discharging aperture through which the test solution is discharged; and
the third substrate comprises a hole providing communication between the groove constituting the second channel and the discharging aperture.

12. The analytical microchannel device according to claim 9, further comprising a first substrate having a groove constituting the first channel, a second substrate a having a groove constituting the second channel, a second substrate b having formed thereon the electrochemical detection-dedicated electrode, and a third substrate having a through aperture for the third channel, the first substrate, the third substrate, the second substrate a, and the second substrate b being stacked atop each other in this order.

13. The analytical microchannel device according to claim 1, further comprising:
a fourth channel substantially parallel to the second channel;
a fifth channel substantially vertically connecting the second channel and the fourth channel to one another; and
an electrochemical detection-dedicated electrode disposed on a floor surface of a portion of the fourth channel, the portion being immediately under the fifth channel and meeting the fifth channel at a substantially right angle.

14. The analytical microchannel device according to claim 13, further comprising: a first substrate having a groove for the first channel and a groove for the fourth groove, and having formed thereon the electrochemical detection-dedicated electrode; a second substrate having a groove for the second channel; and a third substrate having a through aperture for the third channel and a through aperture for the fifth channel, the first substrate, the third substrate, and the second substrate being stacked atop each other in this order.

15. The analytical microchannel device according to claim 14, wherein the first substrate comprises:
an introducing aperture through which the test solution is injected, the introducing aperture being disposed on an upper-stream side of the first channel; and
a discharging aperture through which the test solution is discharged, the discharging aperture being disposed on a lower-stream side of the fourth channel.

16. The analytical microchannel device according to claim 13, further comprising; a first substrate 1a having a groove for the first channel and a groove for the fourth channel; a first substrate 1b having formed thereon the electrochemical detection-dedicated electrode; a second substrate having a groove for the second channel; and a third substrate having a through aperture for the third channel and a through aperture for the fifth channel, the substrate 1b, the first substrate 1a, the third substrate, and the second substrate being stacked atop each other in this order.

17. The analytical microchannel device according to claim 16, wherein the first substrate 1b comprises:
an introducing aperture through which the test solution is injected, the introducing aperture being disposed on an upper-stream side of the first channel; and
a discharging aperture through which the test solution is discharged, the discharging aperture being disposed on a lower-stream side of the fourth channel.

18. The analytical microchannel device according to claim 1, further comprising:
a fourth channel substantially parallel to the second channel;
a plurality of fifth channels substantially vertically connecting the second channel and the fourth channel to one another; and
an electrochemical detection-dedicated electrode disposed in each of inter-inlet regions of the plurality of fifth channels, the inter-inlet regions being located on a floor surface of the second channel.

19. The analytical microchannel device according to claim 18, further comprising: a first substrate having a groove for the first channel and a groove for the fourth groove; a second substrate having a groove for the second channel; and a third substrate having a through aperture for the third channel and a through aperture for the fifth channel, and having formed thereon the electrochemical detection-dedicated electrode, the first substrate, the third substrate, and the second substrate being stacked atop each other in this order.

20. An analytical microchannel device comprising:
a first channel through which a test solution flows;
a second channel substantially parallel to the first channel;
a plurality of third channels substantially vertically connecting the first channel and the second channel to one another; and
a reaction substance-holding portion disposed in each of inter-inlet regions of the plurality of third channels, the inter-inlet regions being located on a floor surface of the first channel, the reaction substance-holding portion being composed of a reaction substance reacting exclusively to a specimen contained in the test solution, the reaction substance being immobilized in the inter-inlet regions.

21. The analytical microchannel device according to claim 20, wherein a wall surface of the first channel immediately above the third channel is slanted toward the third channel.

22. The analytical microchannel device according to claim 20, wherein a wall surface of the second channel immediately under the third channel is slanted toward the third channel.

23. The analytical microchannel device according to claim 20, further comprising a first substrate having a groove constituting the first channel, a second substrate having a groove constituting the second channel, and a third substrate having a through aperture for the third channel, the first substrate, the third substrate, and the second substrate being stacked atop each other in this order.

24. The analytical microchannel device according to claim 20, further comprising an electrochemical detection-dedicated electrode disposed on a floor surface of a portion of the second channel, the portion being immediately under the third channel and meeting the third channel at a substantially right angle.

25. The analytical microchannel device according to claim 20, further comprising:
a fourth channel substantially parallel to the second channel;
a fifth channel substantially vertically connecting the second channel and the fourth channel to one another; and
an electrochemical detection-dedicated electrode disposed on a floor surface of a portion of the fourth channel, the portion being immediately under the fifth channel and meeting the fifth channel at a substantially right angle.

26. The analytical microchannel device according to claim 20, further comprising:
a fourth channel substantially parallel to the second channel;
a plurality of fifth channels substantially vertically connecting the second channel and the fourth channel to one another; and
an electrochemical detection-dedicated electrode disposed in each of inter-inlet regions of the plurality of fifth channels, the inter-inlet regions being located on a floor surface of the second channel.

27. The analytical microchannel device according to claim 26, further comprising: a first substrate having a groove for the first channel and a groove for the fourth groove; a second substrate having a groove for the second channel; and a third substrate having a through aperture for the third channel and a through aperture for the fifth channel, and having formed thereon the electrochemical detection-dedicated electrode, the first substrate, the third substrate, and the second substrate being stacked atop each other in this order.

28. The analytical microchannel device according to claim 27, wherein the first substrate comprises:
an introducing aperture through which the test solution is injected, the introducing aperture being disposed on an upper-stream side of the first channel; and
a discharging aperture through which the test solution is discharged, the discharging aperture being disposed on a lower-stream side of the fourth channel.

29. An analytical microchannel device comprising:
a first channel through which a test solution flows;
a second channel substantially parallel to the first channel;
a third channel substantially vertically connecting the first channel and the second channel to one another;
a filter in the third channel, the filter being substantially parallel to the first channel;
a reaction substance immobilized on a surface of the filter against the first channel, the reaction substance reacting exclusively to a specimen contained in the test solution.

30. The analytical microchannel device according to claim 29, wherein a wall surface of the first channel immediately above the third channel is slanted toward the third channel.

31. The analytical microchannel device according to claim 29, wherein a wall surface of the second channel immediately under the third channel is slanted toward the third channel.

32. The analytical microchannel device according to claim 29, further comprising a first substrate having a groove constituting the first channel, a second substrate having a groove constituting the second channel, and a third substrate having a through aperture for the third channel, the first substrate, the third substrate, and the second substrate being stacked atop each other in this order.

33. The analytical microchannel device according to claim according to claim 32, wherein:
the first substrate comprises an introducing aperture through which the test solution is injected and a discharging aperture through which the test solution is discharged; and
the third substrate comprises a hole providing communication between the groove for the second channel and the discharging aperture.

34. The analytical microchannel device according to claim 29, further comprising an electrochemical detection-dedicated electrode disposed on a floor surface of a portion of the second channel, the portion being immediately under the third channel and meeting the third channel at a substantially right angle.

35. The analytical microchannel device according to claim 34, further comprising a first substrate having a groove constituting the first channel, a second substrate a having a groove constituting the second channel, a second substrate b having formed thereon the electrochemical detection-dedicated electrode, and a third substrate having a through aperture for the third channel, the first substrate, the third substrate, the second substrate a, and the second substrate b being stacked atop each other in this order.

36. The analytical microchannel device according to claim 29, further comprising a first substrate having a groove constituting the first channel, a second substrate having a groove constituting the second channel and having formed thereon the electrochemical detection-dedicated electrode, and a third substrate having a through aperture for the third channel, the first substrate, the third substrate, and the second substrate being stacked atop each other in this order.

37. The analytical microchannel device according to claim according to claim 36, wherein:
the first substrate comprises an introducing aperture through which the test solution is injected and a discharging aperture through which the test solution is discharged; and
the third substrate comprises a hole providing communication between the groove constituting the second channel and the discharging aperture.

38. The analytical microchannel device according to claim 29, further comprising:
a fourth channel substantially parallel to the second channel;
a fifth channel substantially vertically connecting the second channel and the fourth channel to one another; and
an electrochemical detection-dedicated electrode disposed on a floor surface of a portion of the fourth channel, the portion being immediately under the fifth channel and meeting the fifth channel at a substantially right angle.

39. The analytical microchannel device according to claim 38, further comprising: a first substrate having a groove for the first channel and a groove for the fourth groove, and having formed thereon the electrochemical detection-dedicated electrode; a second substrate having a groove for the second channel; and a third substrate having a through aperture for the third channel and a through aperture for the fifth channel, the first substrate, the third substrate, and the second substrate being stacked atop each other in this order.

40. The analytical microchannel device according to claim 39, wherein the first substrate comprises:
an introducing aperture through which the test solution is injected, the introducing aperture being disposed on an upper-stream side of the first channel; and
a discharging aperture through which the test solution is discharged, the discharging aperture being disposed on a lower-stream side of the fourth channel.

41. The analytical microchannel device according to claim 29, further comprising: a first substrate 1a having a groove for the first channel and a groove for the fourth channel, a first substrate 1b having formed thereon the electrochemical detection-dedicated electrode, a second substrate having a groove for the second channel; and a third substrate having a through aperture for the third channel and a through aperture for the fifth channel, the first substrate 1b, the first substrate 1a, the third substrate, and the second substrate being stacked atop each other in this order.

42. The analytical microchannel device according to claim 41, wherein the first substrate 1b comprises:
an introducing aperture through which the test solution is injected, the introducing aperture being disposed on an upper-stream side of the first channel; and
a discharging aperture through which the test solution is discharged, the discharging aperture being disposed on a lower-stream side of the fourth channel.

43. The analytical microchannel device according to claim 29, further comprising:
a fourth channel substantially parallel to the second channel;
a plurality of fifth channels substantially vertically connecting the second channel and the fourth channel to one another; and
an electrochemical detection-dedicated electrode disposed in each of inter-inlet regions of the plurality of fifth channels, the inter-inlet regions being located on a floor surface of the second channel.

44. The analytical microchannel device according to claim 43, further comprising: a first substrate having a groove for the first channel and a groove for the fourth groove; a second substrate having a groove for the second channel; and a third substrate having a through aperture for the third channel and a through aperture for the fifth channel, and having formed thereon the electrochemical detection-dedicated electrode, the first substrate, the third substrate, and the second substrate being stacked atop each other in this order.

45. An analytical microchannel device comprising:
a first channel through which a test solution flows;
a second channel substantially parallel to the first channel;
a flow veering means for substantially vertically bending flow of the test solution through the first channel toward the second channel;
a filter in the vicinity of the flow veering means and in a region between the first channel and the second channel, the filter being substantially parallel to the first channel; and
a reaction substance immobilized on a surface of the filter against the first channel, the reaction substance reacting exclusively to a specimen contained in the test solution.

46. The analytical microchannel device according to claim 45, wherein the flow veering means is defined by a wall provided at an end of the first channel on a lower stream side, the wall being substantially vertical to the first channel.

47. The analytical microchannel device according to claim 45, wherein a wall surface of the first channel immediately above the filter is slanted toward the filter.

48. The analytical microchannel device according to claim 45, wherein a wall surface of the second channel immediately under the filter is slanted toward the filter.

49. The analytical microchannel device according to claim 45, further comprising a first substrate having a groove constituting the first channel, a second substrate having a groove constituting the second channel, and a filter, the first substrate, the filter, and the second substrate being stacked atop each other in this order.

50. The analytical microchannel device according to claim 45, further comprising an electrochemical detection-dedicated electrode disposed on a floor surface of a portion of the second channel, the portion being immediately under the filter.

51. The analytical microchannel device according to claim 50, further comprising a first substrate having a groove constituting the first channel, a second substrate a having a groove constituting the second channel, a second substrate b having formed thereon the electrochemical detection-dedicated electrode, the first substrate, the filter, the second substrate a, and the second substrate b being stacked atop each other in this order.

52. The analytical microchannel device according to claim 50, further comprising a first substrate having a groove constituting the first channel, a second substrate having a groove constituting the second channel and having formed thereon the electrochemical detection-dedicated electrode, the first substrate, the filter, and the second substrate being stacked atop each other in this order.

53. An analytical microchannel device comprising:
a channel A through which a test solution flows;
a channel B substantially parallel to the channel A;
a channel C substantially vertically connecting the channel A and the channel B to one another; and
an electrochemical detection-dedicated electrode disposed on a floor surface a portion of the channel B, the portion being immediately under the channel C and meeting the channel C at a substantially right angle.

54. The analytical microchannel device according to claim 53, further comprising a substrate a having a groove constituting the channel A, a substrate b1 having formed thereon a groove constituting the channel B, a substrate b2 having formed thereon the electrochemical detection-dedicated electrode, and a substrate c having a through aperture for the channel C, the substrate a, the substrate c, the substrate b 1, and the substrate b2 being stacked atop each other in this order.

55. The analytical microchannel device according to claim 53, further comprising a substrate a having a groove constituting the channel A, a substrate b having a groove constituting the channel B and having formed thereon the electrochemical detection-dedicated electrode, and a substrate c having a through aperture for the channel C, the substrate a, the substrate c, and the substrate b being stacked atop each other in this order.

56. The analytical microchannel device according to claim 53, wherein a wall surface of the channel A immediately above the channel C is slanted toward the channel C.

57. The analytical microchannel device according to claim 53, wherein the channel C comprises a plurality of channels.

58. An analytical microchannel device comprising:
a channel A through which a test solution flows;
a channel B substantially parallel to the channel A;
a plurality of channels C substantially vertically connecting the channel A and the channel B to one another; and
an electrochemical detection-dedicated electrode disposed in each of inter-inlet regions of the plurality of channels C, the inter-inlet regions being located on a floor surface of the channel A.

59. The analytical microchannel device according to claim 58, further comprising a substrate a having a groove constituting the channel A, a substrate b having a groove constituting the channel B, and a substrate c having a through aperture for the channel C and having formed thereon the electrochemical detection-dedicated electrode, the substrate a, the substrate c, and the substrate b being stacked atop each other in this order.

60. The analytical microchannel device according to claim 58, wherein a wall surface of the channel B immediately under the channel C is slanted toward the channel C.

61. The analytical microchannel device according to claim 58, wherein a wall surface of the channel A immediately above the channel C is slanted toward the channel C.

62. An analytical microchannel device comprising:
a channel A through which a test solution flows;
a channel B substantially parallel to the channel A;
a flow veering means for substantially vertically bending flow of the test solution through the channel A toward the channel B; and
an electrochemical detection-dedicated electrode disposed immediately under the flow veering means and on a floor surface of the channel B.

63. The analytical microchannel device according to claim 62, wherein the flow veering means is defined by a wall provided at an end of the channel A on a lower stream side, the wall being substantially vertical to the channel A.

64. The analytical microchannel device according to claim 63, further comprising a substrate a having a groove constituting the channel A, and a substrate b having a groove constituting the channel B and having formed thereon the electrochemical detection-dedicated electrode, the substrate a and the substrate b being stacked atop one another.

65. The analytical microchannel device according to claim 63, wherein a wall surface of the channel B disposed in the vicinity of a portion immediately under the flow veering means and in opposition to the filter is slanted toward the filter.

66. The analytical microchannel device according to claim 63, wherein a portion of a wall surface of the channel A in the vicinity of the flow veering means is slanted toward the filter.

67. The analytical microchannel device according to claim 53, wherein the electrochemical detection-dedicated electrode has on a surface thereof a reaction substance reacting exclusively to a specimen contained in the test solution.

68. The analytical microchannel device according to claim 54, wherein the electrochemical detection-dedicated electrode has on a surface thereof a reaction substance reacting exclusively to a specimen contained in the test solution.

69. The analytical microchannel device according to claim 55, wherein the electrochemical detection-dedicated electrode has on a surface thereof a reaction substance reacting exclusively to a specimen contained in the test solution.

70. The analytical microchannel device according to claim 59, wherein the electrochemical detection-dedicated electrode has on a surface thereof a reaction substance reacting exclusively to a specimen contained in the test solution.

71. The analytical microchannel device according to claim 60, wherein the electrochemical detection-dedicated electrode has on a surface thereof a reaction substance reacting exclusively to a specimen contained in the test solution.

72. The analytical microchannel device according to claim 61, wherein the electrochemical detection-dedicated electrode has on a surface thereof a reaction substance reacting exclusively to a specimen contained in the test solution.

73. The analytical microchannel device according to claim 62, wherein the electrochemical detection-dedicated electrode has on a surface thereof a reaction substance reacting exclusively to a specimen contained in the test solution.

74. The analytical microchannel device according to claim 63, wherein the electrochemical detection-dedicated electrode has on a surface thereof a reaction substance reacting exclusively to a specimen contained in the test solution.

75. The analytical microchannel device according to claim 64, wherein the electrochemical detection-dedicated electrode has on a surface thereof a reaction substance reacting exclusively to a specimen contained in the test solution.

76. The analytical microchannel device according to claim 65, wherein the electrochemical detection-dedicated electrode has on a surface thereof a reaction substance reacting exclusively to a specimen contained in the test solution.

77. The analytical microchannel device according to claim 66, wherein the electrochemical detection-dedicated electrode has on a surface thereof a reaction substance reacting exclusively to a specimen contained in the test solution.
